(19) United States
(12) Patent Application Publication
(10) Pub. No.: US 2025/0156593 A1
(43) Pub. Date: May 15, 2025

(54) RAILWAY CONVERTER STATION LINKED TO MEDIUM-VOLTAGE DIRECT CURRENT (MVDC) DISTRIBUTION SYSTEM AND SIMULATION METHOD THEREOF

(71) Applicant: KOREA RAILROAD RESEARCH INSTITUTE, Uiwang-si (KR)

(72) Inventors: Jae Won KIM, Gwacheon-si (KR); Hwan Hee CHO, Anyang-si (KR); Min Sup SONG, Hwaseong-si (KR); Han Min LEE, Seoul (KR); Ho Sung JUNG, Seoul (KR)

(21) Appl. No.: 18/926,977

(22) Filed: Oct. 25, 2024

(30) Foreign Application Priority Data
Nov. 9, 2023 (KR) 10-2023-0154090
Nov. 22, 2023 (KR) 10-2023-0162871
Nov. 22, 2023 (KR) 10-2023-0162878

(51) Int. Cl. G06F 30/13; H02J 1/00; H02M 3/335

(52) U.S. Cl. CPC G06F 30/13; H02J 1/00; H02M 3/33573; H02J 2203/20

(57) ABSTRACT

A simulation system of a railway system for a Medium-Voltage Direct Current (MVDC) distribution network includes: a computing device which stores a simulation program including a converter station model configured to simulate a converter station included in the MVDC distribution network and a train operation model configured to simulate an operation state of a train that is supplied with power from the converter station and runs; a converter controller which controls a DC/DC converter included in the converter station model; and a Hardware In the Loop Simulation (HILS) device which performs a simulation based on the converter station model, the train operation model, and the converter controller. Herein, the converter station model and the train operation model are executed in software by the HILS device, and the converter controller is connected to the HILS device and driven to control the converter station model.

### CROSS-REFERENCE TO RELATED APPLICATION

This application claims the benefit under 35 USC 119 (a) of Korean Patent Application Nos. 10-2023-0154090 filed on Nov. 9, 2023, 10-2023-0162871 filed on Nov. 22, 2023, and 10-2023-0162878 filed on Nov. 22, 2023 in the Korean Intellectual Property Office, the entire disclosures of which are incorporated herein by reference for all purposes.

### TECHNICAL FIELD

The present disclosure relates to a railway converter station linked to a Medium-Voltage Direct Current (MVDC) distribution system and a simulation method thereof.

### BACKGROUND

FIG. 1 illustrates a conventional direct current (DC) railway system.

A typical Korean direct current (DC) railway system is connected to an AC 22.9 kV bus of the distribution system supplied by Korea Electric Power Corporation (KEPCO). This system steps down AC 22.9 kV to AC 1180 V through a rectifier transformer and then converts the voltage to DC 1620 V under no load condition by using a rectifier, such as a diode silicon rectifier, which is then supplied to the railway system.

However, with increasing integration of renewable energy sources, the need to increase the distribution line capacity has been raised, but due to reasons such as public complaints, etc., it is difficult to expand the distribution lines.

Accordingly, research is being conducted on applying a DC system to the distribution system instead of an alternating current (AC) system, which can allow for voltage expansion in terms of insulation level and increase current capacity by alleviating the skin effect.

Currently, the standard transmission voltages in Korea are 765 kV, 345 kV, and 154 kV, and the distribution voltages in use are 22.9 kV for extra high voltage, and 380 V and 220 V for low voltage. The MVDC technology involves converting AC to DC for transmission in the distribution network or directly supplying DC power to users, and (extra) high voltage DC is defined to range from DC 1500 V and DC 100 kV. Therefore, the MVDC voltage range is linked to the 22.9 kV distribution system prior to a transformer.

### 1. Necessity for Virtual Simulation System for DC Railway Converter Station

Since this DC railway system is linked, as a load, to a 22.9 kV bus of the distribution system supplied by KEPCO, it is required to change traction substations, which are the connection points between the DC railway system and the distribution system, into MVDC-linked infrastructures when applying the MVDC technology to the distribution system. That is, in order to convert high DC voltages of the KEPCO distribution system to railway operating voltages (3000 V, 1500 V, 750 V) and to secure operational flexibility, it is required to develop a DC/DC converter-based DC railway converter station capable of active voltage control.

Accordingly, the present disclosure proposes a method for configuring a railway converter station necessary for linking the railway system to the MVDC distribution network, and a method for virtual simulation by using a controller hardware and implementing a train, which is a key component as a moving load, in a software environment to pre-verify the converter station without a field test.

### 2. Necessity for Improving Simulation Algorithm

Meanwhile, it is required to improve an algorithm used in a simulation process of the DC railway converter station. That is, in order to implement a virtual operation based on real-time simulation without a railway vehicle, real-time performance needs to be ensured and a fast computation-based power simulation method is needed to simulate a DC railway system including a railway vehicle which is a moving load.

According to a conventional power simulation technology, a train operation simulation based on batch processing has been utilized. In this simulation, traction and braking force curves prepared based on design performance values of motors used in railway vehicle design are utilized to receive all of vehicle data, operation data, and track data (curve, gradient, station location information) and cumulatively process data for all of given routes based on time, distance, or speed.

According to the conventional technology, the result (speed profile and power profile) of the train operation simulation based on batch processing is input again to perform a power simulation for calculating the current and voltage of each node by using programming or simulation tools.

That is, the most significant feature of the conventional technology is sequential data processing. Sequential data processing refers to a method of collecting bounded data (by route or time, such as hours or minutes) in a predetermined period of time and then processing the data sequentially at a specific point in time.

FIG. 2 is a flowchart showing a conventional power simulation process.

As shown in FIG. 2, the overall power simulation process is largely divided into a train operation computation process and a power simulation process, each performed by separate computational algorithms.

First, when the train operation computation begins, all of train data input information, such as vehicle data, operation data, and track data (curve, gradient, station location information), is input and parameterized and then pre-batch processing of train operation is performed. The pre-batch processing of train operation uses the train data input information to pre-calculate an acceleration-coasting transition point and a coasting-braking transition point.

The acceleration-coasting transition point is selected considering the operating conditions and environment of the train, but sections with short distances between stations (referring to start and end stations; a set of the current and next target stations) are not selected. The coasting-braking transition point is obtained by obtaining a train speed trajectory through forward travel considering a traction force curve and a train speed trajectory through reverse travel considering a braking force curve, and determining the intersection of these two trajectories considering the respective locations of start and end stations of the train.

Then, the train operation computation begins based on the calculated result of the pre-batch processing of train operation. First, the acceleration is calculated by considering the traction force or braking force and running resistance, and the corresponding time and values are simultaneously stored in a look-up table or array format. Then, the acceleration and a predefined unit time (sample time) are used to calculate the speed and location and also store them in a table or array format. Further, these values are used to calculate and store a power consumption value. In this case, the power consumption value can be calculated based on the product of the traction force and speed or the braking force and speed.

If a mode transition (acceleration, coasting, or braking) occurs according to the look-up table derived from the pre-batch processing of train operation, the mode is switched and the traction force is set to be positive during acceleration, zero (0) during coasting, and negative during braking, and the calculation is performed again. If no transition occurs, the process is repeated. If an interruption condition is met or the current location of the train exactly matches the station location, the algorithm ends.

Then, the power simulation process is performed by a separate algorithm. Power simulation includes a case where a simulation tool that is separately modeled is used and a case where the solution is obtained by numerically solving a differential equation. First, initial values and conditions are set, and the values from the consumption power look-up table (array) derived from the train operation computation process are read and parameterized or read at each accumulated time and then, input to an equivalent model (including a mathematical model) in which the current of the train consumption power is converted and expressed as a current source or impedance. A coefficient matrix is calculated through state-space equations. Finally, through calculation of the state-space equations, the voltage, current, and power are derived and stored as the output of a continuous or discrete-time system, and the process ends. In other words, the conventional technology is characterized by transition to three modes (states) including acceleration, coasting, and braking, and requires a pre-calculation for each section between stations.

However, according to the conventional batch processing method for train operation simulation, it is difficult to retrieve data in real time. That is, according to the batch processing method, it is impossible to perform another operation, i.e., the power simulation process, until the train operation computation process is completed. When this processing method is applied to a real-time railway power simulation, the accuracy and size of input data can be affected.

In addition, when the batch processing is applied to a real-time simulation, the result of the batch processing for train operation simulation is temporarily stored in cache memory before the simulation, but for a large amount of data, there are limitations in storage, utilization, and fast computation required for real-time simulation.

### 3. Necessity for Improving DC/DC Converter of Converter Station

In various industrial fields where the reuse of regenerative power is needed, such as railway vehicles, electric vehicles, and photovoltaic systems, a Dual Active Bridge (DAB) converter is widely used for bidirectional power conversion. The DAB converter, which has a symmetrical dual bridge switching stack with a series inductor in between, offers advantages, such as structural simplicity, Zero Voltage Switching (ZVS) turn-on characteristics of all of primary and secondary side switches, and spontaneous redirection.

However, the typical DAB converter tends to lose its ZVS characteristics when a load is low, and as the load increases, conduction losses rise due to the presence of reactive power components in a circuit.

To solve this problem, a Series-Resonant DAB (SRDAB) converter combined with a series inductor and a tuned resonant capacitor has been proposed. The SRDAB converter, like a conventional DAB converter, allows for easy adjustment of power magnitude and flow by controlling a phase difference between two bridges, and maintains ZVS characteristics over a wide area.

However, the resonant and non-resonant DAB converters known so far are typically based on either a Full-Bridge (FB) or Half-Bridge (HB) configuration, and a switching voltage that can be handled by a 2-level topology is relatively low, typically under several hundred volts. In order to switch higher voltages, such as DC 1500 V or more used in railway vehicles, a modular structure with an Input-Series-Output-Parallel (ISOP) configuration, where DAB converters are stacked in series and their outputs are connected in parallel, is needed. However, this structure demands a large number of switching elements and includes an additional passive component for each module, which increases the number of active and passive components in the system.

FIG. 3 illustrates a conventional 2-level FB SRDAB converter, and FIG. 4 illustrates SRDAB converters having the ISOP structure.

Since the converter illustrated in FIG. 3 is based on a 2-level converter, a switching rated voltage that each switch can handle is an input source voltage, Vdc. The illustrated converter circuit is composed of four input side switches, four output side switches, a resonant inductor Lr, a resonant capacitor Cr, a transformer with a winding ratio of n:1, input and output filter capacitors, and a load resistor R.

As described above, since the input stage is based on a 2-level FB configuration, an Input-Series-Output-Parallel (ISOP) structure is needed to be applied to a power conversion system, such as a railway vehicle, with a high input source voltage.

As shown in FIG. 4, an ISOP structure can be used by stacking two unit converters of FIG. 3 in series on the input side and two unit converters of FIG. 3 in parallel on the output side. The entire circuit is composed of eight input side switches, eight output side switches, four resonant components (inductors and capacitors), two transformers, two input capacitors, and one output capacitor. It can be seen that when the ISOP structure is configured, the number of input switches and the number of resonant components double. Also, it can be seen that the input side is configured in series, and, thus, a separate control means is required to control neutral point fluctuations of the capacitors.

### PRIOR ART DOCUMENT

### Patent Document

Korean Patent No. 10-2213266 (entitled “Configuration method and system for urban rail transit regenerative braking energy recycling devices”)

### SUMMARY

In view of the foregoing, the present disclosure is conceived to provide a railway converter station linked to an MVDC distribution system used in a DC railway system, and a simulation system for the same.

Also, the present disclosure is conceived to provide a train operation simulation device and method which can be used for a railway converter station linked to an MVDC distribution system used in a DC railway system.

Further, the present disclosure is conceived to provide a series-resonant DAB (SRDAB) converter, which can be used for a railway converter station linked to an MVDC distribution system used in a DC railway system, and a method of controlling the same.

The problems to be solved by the present disclosure are not limited to the above-described problems. There may be other problems to be solved by the present disclosure.

An aspect of the present disclosure provides a simulation system of a railway system for a Medium-Voltage Direct Current (MVDC) distribution network, including: a computing device which stores a simulation program including a converter station model configured to simulate a converter station included in the MVDC distribution network and a train operation model configured to simulate an operation state of a train that is supplied with power from the converter station and runs; a converter controller which controls a DC/DC converter included in the converter station model; and a Hardware In the Loop Simulation (HILS) device which performs a simulation based on the converter station model, the train operation model, and the converter controller. Herein, the converter station model and the train operation model are executed in software by the HILS device, and the converter controller is connected to the HILS device and driven to control the converter station model.

Another aspect of the present disclosure provides a method of simulating a railway system for an MVDC distribution network, including: a process of executing a simulation program, which includes a converter station model configured to simulate a converter station included in the MVDC distribution network and a train operation model configured to simulate an operation state of a train that is supplied with power from the converter station and runs, in software by an HILS device; and a process of connecting a converter controller, which controls a DC/DC converter included in the converter station model, to the HILS device and driving the converter controller to control the converter station model.

According to the present disclosure, a configuration and method are proposed to verify HILS of a railway system by using a controller. Thus, it is possible to pre-verify operational algorithms for the railway system without a field test or an end product. By analyzing the result of the virtual simulation obtained in this way and applying it to manufacturing and performance testing of vehicles, it is possible to achieve efficient optimization.

Also, according to the present disclosure, it becomes easy to establish a system operation plan by deploying a plurality of railway vehicles with similar operating patterns. Further, there is no need to consider the time intervals of the train operation simulation, and, thus, a power simulation environment can be synchronized visually. In contrast to conventional train operation and power simulation technologies by which an operation of a plurality of railway vehicles is simulated based on a received train diagram, the present disclosure allows for the generation and output of a train diagram. Furthermore, the size of input data is small enough to be parameterized, which enables the implementation and deployment of high-speed train operation computation modules based on a state machine stream processing method within a traction inverter controller to simulate an actual railway operation environment. Moreover, according to the present disclosure, the system operates based on a state machine and thus is highly stable. That is, the train operates in only one state at a time, the flow follows the design exactly, and state transitions occur only through predetermined events.

Further, according to the present disclosure, due to the configuration of the series-resonant DAB (SRDAB) converter, the number of active and passive components in the primary side bridge can be reduced by half compared to a conventional Full-Bridge (FB) under the same rated voltage conditions. Meanwhile, the implementation of the proposed method requires a special switching sequence. In the present disclosure, a switching pattern based on voltage magnitude modulation instead of conventional phase shifting is employed to present a special sequence for controlling neutral point balancing.

### BRIEF DESCRIPTION OF THE DRAWINGS

In the detailed description that follows, embodiments are described as illustrations only since various changes and modifications will become apparent to a person with ordinary skill in the art from the following detailed description. The use of the same reference numbers in different figures indicates similar or identical items.

FIG. 1 illustrates a conventional direct current (DC) railway system.

FIG. 2 is a flowchart showing a conventional power simulation process.

FIG. 3 illustrates a conventional 2-level FB SRDAB converter.

FIG. 4 illustrates SRDAB converters having the ISOP structure.

FIG. 5 illustrates a configuration of a railway system for an MVDC distribution network according to an embodiment of the present disclosure.

FIG. 6 is a block diagram illustrating a configuration of a simulation system of the railway system for the MVDC distribution network according to an embodiment of the present disclosure.

FIG. 7 is a block diagram illustrating a configuration of a computing device included in the simulation system according to an embodiment of the present disclosure.

FIG. 8 is a flowchart showing processes of a train operation model based on a stream processing method according to an embodiment of the present disclosure.

FIGS. 9, 10A, 10B, 10C, 11, and 12 are diagrams for explaining a train operation computation process based on a state machine according to an embodiment of the present disclosure.

FIGS. 13A, 13B, 13C, and 13D show the result of computation performed by the train operation model according to an embodiment of the present disclosure.

FIGS. 14A, 14B, 14C, and 14D show examples of an equivalent model of the railway system used in the train operation model according to an embodiment of the present disclosure.

FIGS. 15A, 15B, and 15C illustrate a process of analyzing the equivalent model of the railway system used in the train operation model according to an embodiment of the present disclosure.

FIG. 16 illustrates an SRDAB converter applied to a converter station model according to an embodiment of the present disclosure.

FIG. 17 illustrates an Input-Series-Output-Parallel (ISOP) connection state of SRDAB converters applied to the converter station model according to an embodiment of the present disclosure.

FIG. 18 is provided to explain an operation of the SRDAB converter according to an embodiment of the present disclosure.

FIG. 19 shows primary and secondary side leg voltage waveforms of the SRDAB converter according to an embodiment of the present disclosure.

FIG. 20 shows a case where a switching sequence based on a typical phase shifting technique is applied to the present disclosure.

FIGS. 21 and 22 show switching sequences based on pulse amplitude modulation for driving the SRDAB converter according to the present disclosure.

FIGS. 23A and 23B show a relationship between a carrier and a pulse-width modulation (PWM) command value in a method of driving the SRDAB converter according to an embodiment of the present disclosure.

FIG. 24 shows a process of selecting a command mode CM in the method of driving the SRDAB converter according to an embodiment of the present disclosure.

FIGS. 25, 26, and 27 are block diagrams of a control logic that outputs control signals for the SRDAB converter according to an embodiment of the present disclosure.

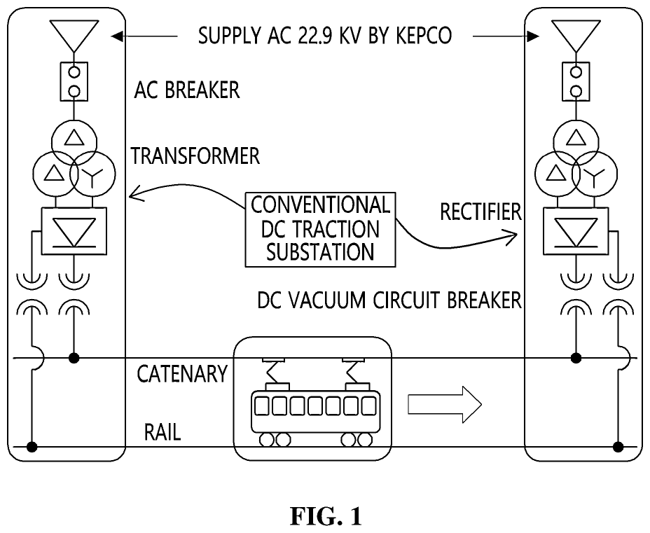

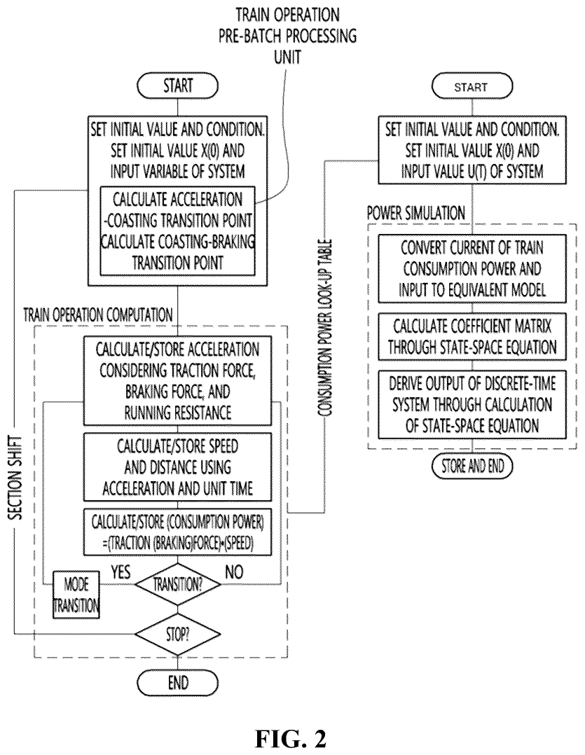

### DETAILED DESCRIPTION

Hereafter, embodiments will be described in detail with reference to the accompanying drawings so that the present disclosure may be readily implemented by a person with ordinary skill in the art. However, it is to be noted that the present disclosure is not limited to the embodiments but can be embodied in various other ways. In the drawings, parts irrelevant to the description are omitted for the simplicity of explanation, and like reference numerals denote like parts through the whole document.

Throughout this document, the term “connected to” may be used to designate a connection or coupling of one element to another element and includes both an element being “directly connected to” another element and an element being “electronically connected to” another element via another element.

Through the whole document, the term “on” that is used to designate a position of one element with respect to another element includes both a case that the one element is adjacent to the other element and a case that any other element exists between these two elements.

Further, through the whole document, the term “comprises or includes” and/or “comprising or including” used in the document means that one or more other components, steps, operation and/or existence or addition of elements are not excluded in addition to the described components, steps, operation and/or elements unless context dictates otherwise. Through the whole document, the term “about or approximately” or “substantially” is intended to have meanings close to numerical values or ranges specified with an allowable error and intended to prevent accurate or absolute numerical values disclosed for understanding of the present disclosure from being illegally or unfairly used by any unconscionable third party. Through the whole document, the term “step of” does not mean “step for”.

Through the whole document, the term “unit” includes a unit implemented by hardware or software and a unit implemented by both of them. One unit may be implemented by two or more pieces of hardware, and two or more units may be implemented by one piece of hardware. Meanwhile, the units are not limited to the software or the hardware, and each of the units may be stored in an addressable storage medium or may be configured to implement one or more processors. Accordingly, the units may include, for example, software, object-oriented software, classes, tasks, processes, functions, attributes, procedures, sub-routines, segments of program codes, drivers, firmware, micro codes, circuits, data, database, data structures, tables, arrays, variables and the like. The components and the functions of the units can be combined with each other or can be divided up into additional components and units.

Hereafter, exemplary embodiments of the present disclosure will be described in detail with reference to the accompanying drawings and description. However, the present disclosure is not limited to the following embodiments and can be embodied in a different form. Like reference numerals generally denote like elements throughout the present specification.

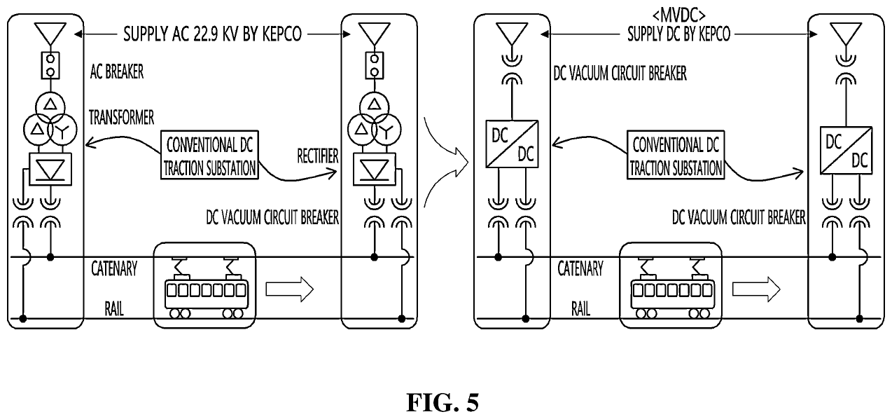

FIG. 5 illustrates a configuration of a railway system for an MVDC distribution network according to an embodiment of the present disclosure.

In FIG. 5, the left side illustrates a conventional DC railway system, while the right side illustrates a DC railway system according to the present disclosure.

The DC railway system according to the present disclosure converts a DC voltage of a distribution system into a railway operating voltage through a DC/DC converter-based DC railway converter station. The DC railway converter station uses the DC/DC converter capable of converter-based active control.

Meanwhile, a field test using actual railway infrastructure is needed to test a newly developed DC railway converter station during the development of power equipment. However, such a test carries significant risks, such as train operation disruptions and human accidents, in the event of an incident during the test. Further, the difficulty of repeating tests results in low efficiency.

Furthermore, the verification and optimization of system performance using actual railway vehicles requires a substantial amount of time and financial support. Moreover, there are limitations on various tests and repeated testing depending on a testbed environment.

Therefore, to perform safe repeated testing for verifying the performance of the new system (power equipment) and analysis thereof, it is required to develop a virtual operation technology that can evaluate the operational efficiency of the target power equipment according to its intended use. This can be achieved by constructing a Hardware In the Loop Simulation (HILS) platform based on a real-time simulator and controller hardware at a laboratory scale.

That is, a DC/DC converter controller of the converter station is implemented in hardware, while the other parts are implemented in a software-based virtual environment to enable a virtual operation.

In order to implement a virtual operation based on real-time simulation without a railway vehicle, real-time performance needs to be ensured and a fast computation-based power simulation method is needed to simulate a DC railway system including a railway vehicle which is a moving load.

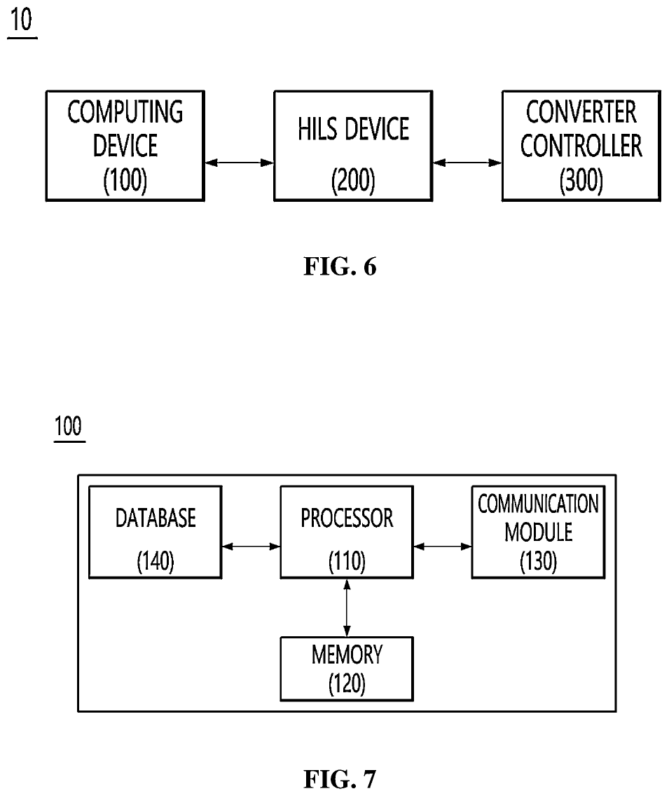

FIG. 6 is a block diagram illustrating a configuration of a simulation system of the railway system for the MVDC distribution network according to an embodiment of the present disclosure.

A simulation system 10 illustrated in FIG. 6 includes a computing device 100, an HILS device 200, and a converter controller 300.

The computing device 100 stores a simulation program including a converter station model configured to simulate a converter station included in an MVDC distribution network and a train operation model configured to simulate an operation state of a train that is supplied with power from the converter station and runs.

The HILS device 200 is configured to allow various simulations to be performed during the development of a real-time embedded system. The HILS device 200 mathematically models an operating environment or system of the equipment being tested to perform simulations. The HILS device 200 itself is based on a conventional technology, but in the present disclosure, the HILS device 200 is utilized to simulate the converter station. To ensure that the HILS device 200 operates as if the converter controller 300, which is an actual hardware controller of the railway system being tested, were in a real environment, it is essential to construct a real-time simulation environment.

The converter controller 300 includes a processor equipped with a control logic that controls the DC/DC converter, which is a key component of the converter station being tested. The converter controller 300 performs a control operations of the DC/DC converter in conjunction with a real-time simulator IO of the HILS device 200 (e.g., a DI (PWM) card). A processor, such as an MCU or an FPGA, may be included in the converter controller 300, and a specific configuration of the control logic will be described later.

FIG. 7 is a block diagram illustrating a configuration of a computing device included in the simulation system according to an embodiment of the present disclosure.

The computing device 100 may include a processor 110 and a memory 120, and may further include a communication module 130 and a database 140.

A simulation program is stored in the memory 120. The simulation program includes the converter station model configured to simulate the converter station included in the MVDC distribution network and the train operation model configured to simulate an operation state of a train that is supplied with power from the converter station and runs.

Further, the memory 120 functions to temporarily or permanently store data processed by the processor 110. Herein, the memory 120 may include volatile storage media or non-volatile storage media, but the present disclosure is not limited thereto.

The processor 110 executes the simulation program stored in the memory 120. Also, the processor 110 performs various control operations for operating the computing device 100. Herein, the processor 110 refers to a data processing device embedded in hardware, which has a physically structured circuit for performing functions represented as codes or commands included in the program. Examples of the data processing device embedded in hardware may include processing devices, such as a microprocessor, a central processor (CPU), a processor core, a multiprocessor, an application-specific integrated circuit (ASIC), a field programmable gate array (FPGA), a graphics processing unit (GPU), etc., but the present disclosure is not limited thereto.

The communication module 130 may include one or more components that transmit and receive various types of data with an external computing device. The communication module 130 may be a device that includes hardware and software necessary to transmit and receive signals, such as control signals or data signals, through wired or wireless connections with other network devices.

The database 140 can manage various data necessary to execute the simulation program.

Hereafter, a detailed configuration of the simulation program will be described.

As described above, the simulation program includes the converter station model and the train operation model. In response to a user's request, the train operation model and the converter station model are uploaded to the HILS device 200 and each of the train operation model and the converter station model is executed. When the train operation model is executed, a train operation simulation program operates, and when the converter station model is executed, a converter station simulation program operates. Assuming that the converter station model is installed in the DC railway system, the train operation simulation is performed according to the train operation model.

An offline simulation requires tens of hours of computation to implement a simulation for a few minutes at most. In contrast, a real-time simulation using a real-time simulator shows the same implementation time as the actual time (1 second in the simulation is equal to 1 second in reality) and can be performed for several minutes to hours. Therefore, it is highly useful for pre-validation.

### 1. Configuration of Train Operation Simulation Program

The train operation model is implemented as a moving load within a real-time simulator according to a train operation computation logic, and a fast computation-based power simulation method is required to simulate a virtual operation of a DC railway system.

First, considering the accuracy of the train operation model, if a simulation result shows that a computation interval Ttps is around 1 second, which is much longer than a power system's response (time constant, in the range of tens of microseconds), a control sampling frequency or control time interval Tc of a controller of a converter station can also be included in key control variables. Thus, the problem of finding the solution of the entire power system increases in stiffness depending on a relationship among the computation interval Ttps, a time interval Ts of a discrete-time system, and the control time interval Tc. A numerical instability may occur depending on the size of a the computation interval Ttps, and the robustness of the result from numerical analysis may decrease.

Further, if the computation interval Ttps is set to be very small to improve the accuracy in terms of the size of input data, the size of data in the result of the train operation simulation based on batch processing becomes very large. Data with a greater size are stored sequentially in the form of a text file and subjected again to split or batch reading (input) and processes for power simulation, which results in a decrease in efficiency of computation. If a stream processing method according to the present disclosure is applied to solve this problem, it is possible to lower a time interval to a minimum level (less than a few hundred microseconds) required to ensure the real-time performance of the entire power system including the train operation model. The concept of a state machine is introduced to apply the stream processing method to the train operation model, and, thus, it is possible to solve the above-described problem of the size or accuracy of input data.

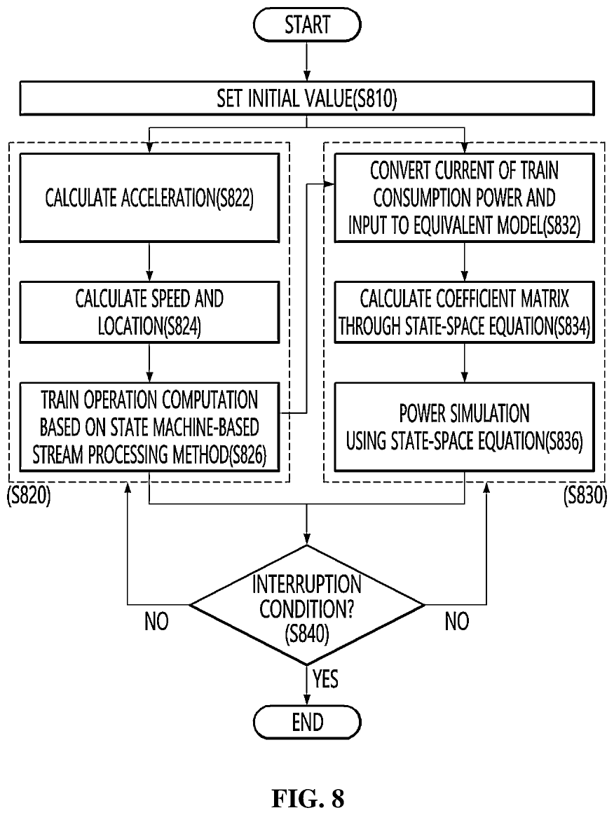

FIG. 8 is a flowchart showing processes of a train operation model based on a stream processing method according to an embodiment of the present disclosure.

First, an initial value x(0) and an input value u(t) of the system are set (S810).

Herein, x(0) denotes an initial value of the system and may include an initial speed (0 km/h), an initial location (0 km), an initial train torque (0 kN), an initial acceleration (0 km/h/s), and an initial consumption/regenerative power (0 kW). Also, u(t) denotes a power value of the train which changes over time, and x(t) denotes a system state variable that changes over time, such as speed, location, acceleration, train torque, consumption power, or regenerative power. Further, u(t) is determined in the train operation computation process S820, and x(t) is determined in the power simulation process S830.

Then, the train operation computation is performed based on the state machine-based stream processing method (S820).

More specifically, the train operation computation S820 may include a process of calculating an acceleration in consideration of a traction force and a running resistance or a braking force and a running resistance (S822), a process of calculating a speed and a location by using the acceleration and a unit time (time interval Ts of the discrete-time system) (S824), and a process of performing train operation computation based on the state machine-based stream processing method and returning a final notch and a train power consumption value (S826).

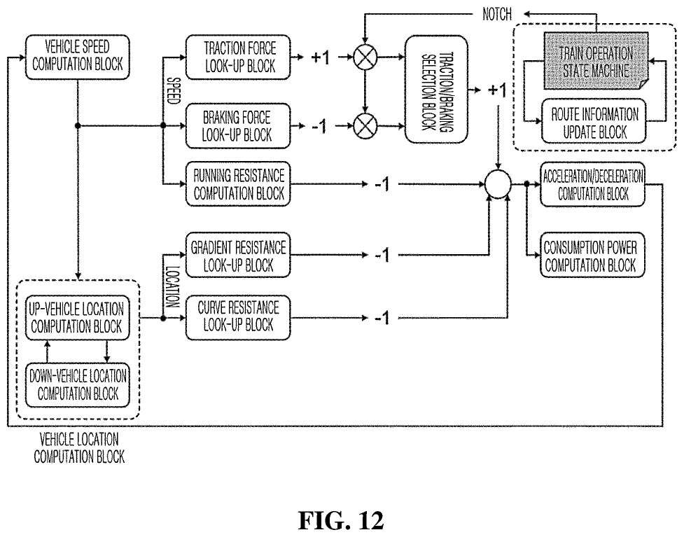

The process of calculating the acceleration (S822) involves calculating an acceleration by using the traction force, braking force and running resistance determined depending on the speed and the notch value determined by a train operation state machine as shown in FIG. 12. The notch value is used to select one of traction and braking force curves. When the traction force curve or braking force curve is selected, a current speed is mapped to one of the two curves to calculate a torque of the train and an acceleration or deceleration is calculated by dividing the calculated torque by the mass of the train.

The process of calculating the speed and the location (S824) uses the acceleration and the unit time (time interval Ts of the discrete-time system). The unit time (time interval) is used to calculate a next calculation value (speed, location, acceleration, etc.) based on the current calculation value (speed, location, acceleration, etc.). For example, the next speed may be calculated from the current speed and expressed as v=v0+a*Ts.

The notch value output in the process S826 may be returned to the previous process S822, and the train power consumption value may be returned to a process S832.

As the notch value and train power consumption value are returned, the train operation computation is repeated again and a train power consumption value output through computation is input in the power simulation process S830. Herein, the notch refers to a controller used by a train driver to adjust the speed during train operation, and represents a notch state value (e.g., P4˜, P1, N, B1˜B7) during train operation.

Then, the train power consumption output from the previous process S820 is received as an input and a power simulation is performed by using state-space equations (S830).

More specifically, the power simulation process S830 may include a process of dividing the train consumption power by the voltage to input it to an equivalent model as a current source (S832), a process of configuring the entire power system including the current source (train load) with state-space equations and calculating a coefficient matrix (S834), and a process of deriving an output of a discrete-time system through calculation of the state-space equations and starting the power simulation again (S836).

Meanwhile, the train operation computation S820 and the power simulation S830 can be performed in parallel and repeated until an interruption condition is met (S840). When the interruption condition is met, the result of each computation is stored and the simulation ends. One of the features of the present disclosure is that the simulation can be performed without interruption. Thus, when the user requests to stop the entire simulation, it is determined that the interruption condition is met.

Hereafter, the above-described train operation computation process S820 based on the state machine-based stream processing method will be described in more detail.

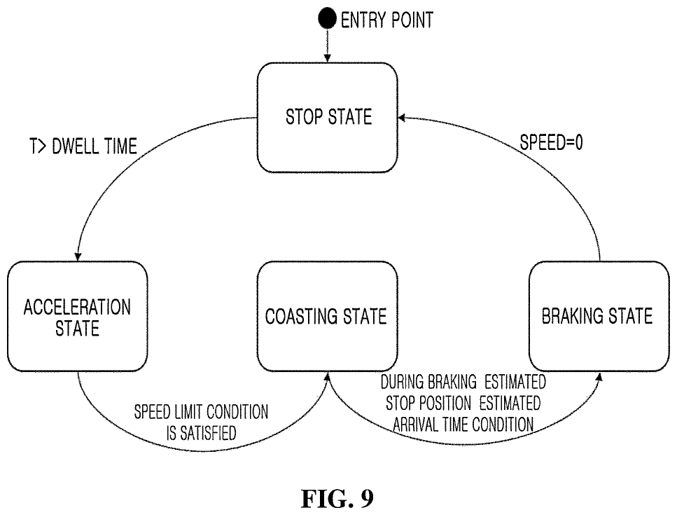

FIG. 9 to FIG. 12 are diagrams for explaining a train operation computation process based on a state machine according to an embodiment of the present disclosure.

First, in the train operation computation process S826, the system checks state information based on the speed calculated in the previous step S824 and outputs a notch value corresponding thereto.

As shown in FIG. 9, the state machine consists of four states: stop state, acceleration state, coasting state, and braking state. First, the state machine enters the stop state through an entry point. It does not apply at first, but after a certain period of stop time, the state machine transitions to the acceleration state. Then, the state machine checks whether the calculated speed satisfies a speed limit condition of the following Equation 1, and if the condition is satisfied, the state machine transitions to the coasting state.

$$V - {V}_{LIM} < ϵ \qquad [ Equation 1 ]$$

That is, the state machine checks whether a difference between a current running speed V and a speed limit VLIM is smaller than a threshold value, and if the condition is satisfied, the state machine enters the coasting state. In this case, the entry point is in a 0-notch (N) state. However, in the acceleration state, excessive notch control may be suppressed and the sensitivity of state transitions may be lowered by introducing a speed deadband (δ) as shown in Equation 2 in order to perform toothed control.

$$V - {V}_{LIM} < ϵ + δ \qquad [ Equation 2 ]$$

That is, the state machine consists of stop state, acceleration state, coasting state, and braking state, and the states of the state machine transition depending on whether the speed reaches the speed limit and notch values matched with the respective states are output.

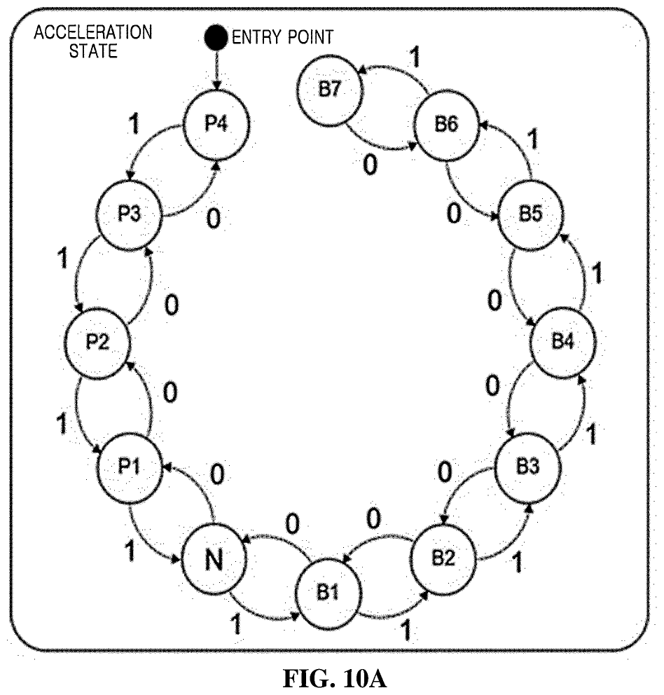

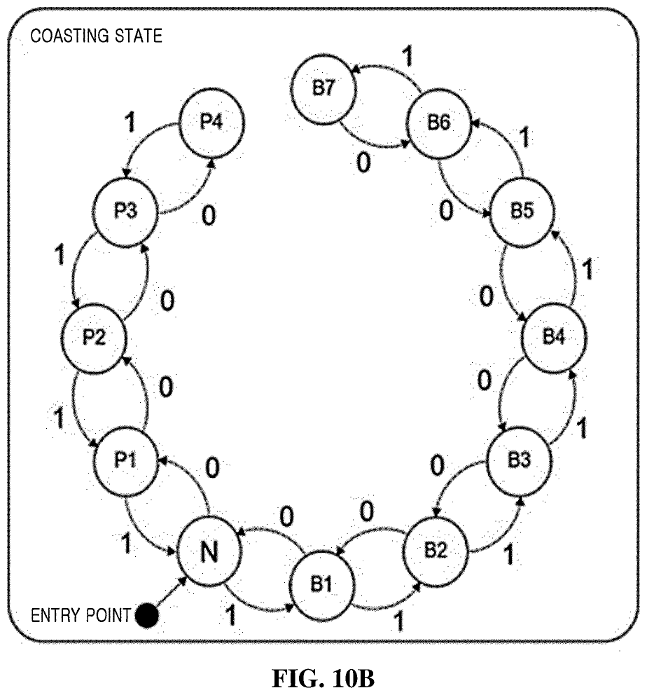

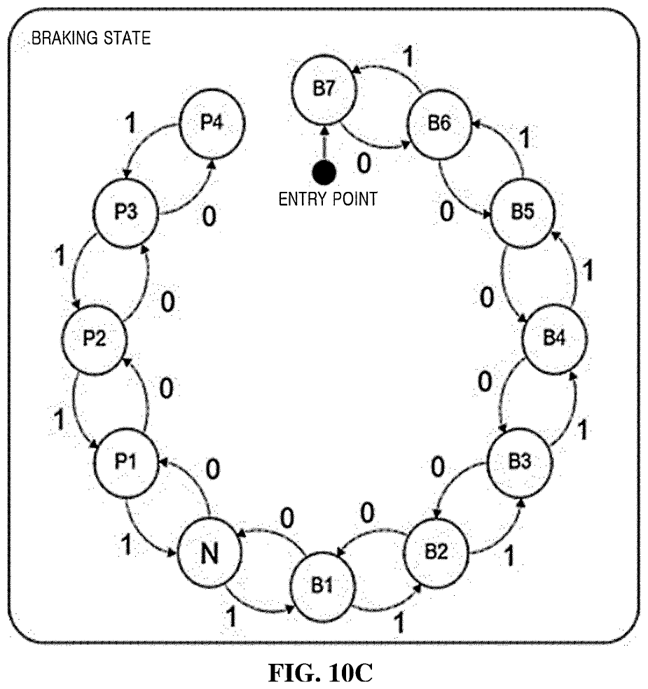

FIGS. 10A to 10C are state machine diagrams showing mascon (notches) in the acceleration state, the coasting state and the braking state, respectively. In the acceleration state, when Equation 1 is met, a notch value is 1, and when Equation 1 is not met, a notch value is 0. When the notch value is 1, the state transitions in the direction of increasing speed, and when the notch value is 0, the state transitions in the direction of decreasing speed. Herein, an arbitrary value ε may decrease counterclockwise as the reference.

As shown in FIG. 10B, in the coasting state, when Equation 2 is met, the notch value is 1, and when Equation 2 is not met, the notch value is 0. When the notch value is 1, the state transitions in the direction of increasing speed, and when the notch value is 0, the state transitions in the direction of decreasing speed. Herein, an arbitrary value ε may decrease counterclockwise as the reference.

As shown in FIG. 10C, in the braking state, an operation target time for a section at an average speed and a braking point at a maximum torque for a current operation location are calculated first, and if an arrival condition is met, the state transitions and an entry point is set to handle a notch for maximum braking power, B7. In the stop state, the state transitions when the speed equals 0. In this case, a dwell time starts to be counted and a set of a current station and a next station is shifted one section at a time.

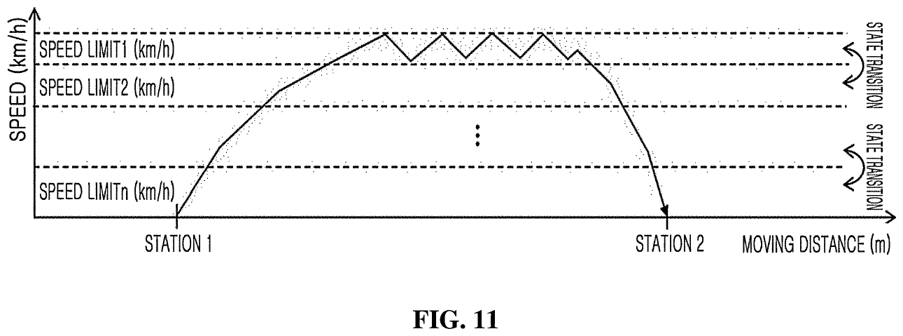

Referring to the example shown in FIG. 11, when a train operational speed profile is derived, speed limits are set for respective sections, and when the conditions satisfying the speed limits are met as shown in Equations 1 and 2, the state transitions. That is, at the time of departure from station 1, the state begins with a notch P4 with a maximum traction force. When the speed reaches a first speed limit (speed limit n) and satisfies Equations 1 and 2, the state transitions to a next state (P3), and when the speed continues to increase and reaches a maximum speed limit (speed limit 1), the state transitions to the coasting state at a notch N. Then, when the speed decreases below the speed limit, the state transitions to a notch B1 with a braking force, and state transitions are repeated in the braking state until the train is braked at an exact point of station 2, which is the final station. In this way, the train operation can be calculated using only state transitions, without any computation such as prior estimation of braking points.

Also, it is possible to modify the embodiment by objectifying the train driver's pattern and reflecting the notch handling sensitivity of the train in the train operation state machine. This enables more realistic train operation computation and allows for random variations in train operation and thus provides probabilistic optimal efficiency for system operation in future power system simulations (numerical computation of the power system). In particular, this differs from a conventional batch processing for train operation simulation where a deterministic result is obtained through extreme operation handling of the notch P4 (acceleration), the notch 0 (coasting), and the notch B7 (braking), but a train operation (electric load model) is somewhat unrealistic.

Furthermore, in a route with frequent speed limit changes, the train driver's awareness of speed limit can be reflected in the train operation state machine. During the train operation computation, the speed limit may change suddenly. For example, when the train running at 70 km/h under an 80 km/h speed limit suddenly encounters a 50 km/h speed limit, even rapid deceleration may not prevent the train from exceeding the speed limit according to the result of computation. To solve this problem, a speed limit-distance table can be parameterized in advance and reflected in the state machine diagram, which allows the state to transition to the braking state at a specific distance to reduce the speed.

FIG. 12 shows an example of an algorithm for calculating train power consumption during the train operation computation process.

The train operation model calculates an acceleration/deceleration and a consumption power by using an acceleration/deceleration computation block and a consumption power computation block to compute train power consumption. The values input into the acceleration/deceleration computation block and the consumption power computation block are the outputs from a traction/braking selection block, a running resistance computation block, a gradient resistance look-up block, and a curve resistance look-up block.

First, a traction force look-up block or a braking force look-up block stores pre-matched information of a traction force or a braking force according to the vehicle's speed value. When the speed value is input, the corresponding traction force or braking force is output. In consideration of the notch value derived in the previous process S826, the traction and braking forces are derived.

The running resistance computation block outputs a running resistance by inputting the speed value into a pre-determined equation.

The gradient resistance look-up block and the curve resistance look-up block store pre-matched information of a gradient resistance and a curve resistance, respectively, based on the location. When the vehicle's location information is input, the corresponding gradient or curve resistance is output. In this case, location information can be derived based on the speed and travel time derived in the previous process S824 or can be identified through a global positioning system (GPS).

Based on the collected information, the acceleration/deceleration computation block and the consumption power computation block calculate and output an acceleration or deceleration and a consumption power corroding to pre-determined equations, respectively. For example, the acceleration or deceleration can be calculated as a=F/m (where a is an acceleration or deceleration, F is a traction force or a braking force, and m is the mass of the train). Also, the consumption power (or regenerative power) can be calculated as P=Fv (where P is a consumption power or regenerative power, F is a traction force or a braking force, and v is a current speed of the train).

Accordingly, when the operation for a section is completed, route information is updated, an up operation ends, and an up-vehicle location computation block is switched to a down-vehicle location computation block, which allows for continuous calculation.

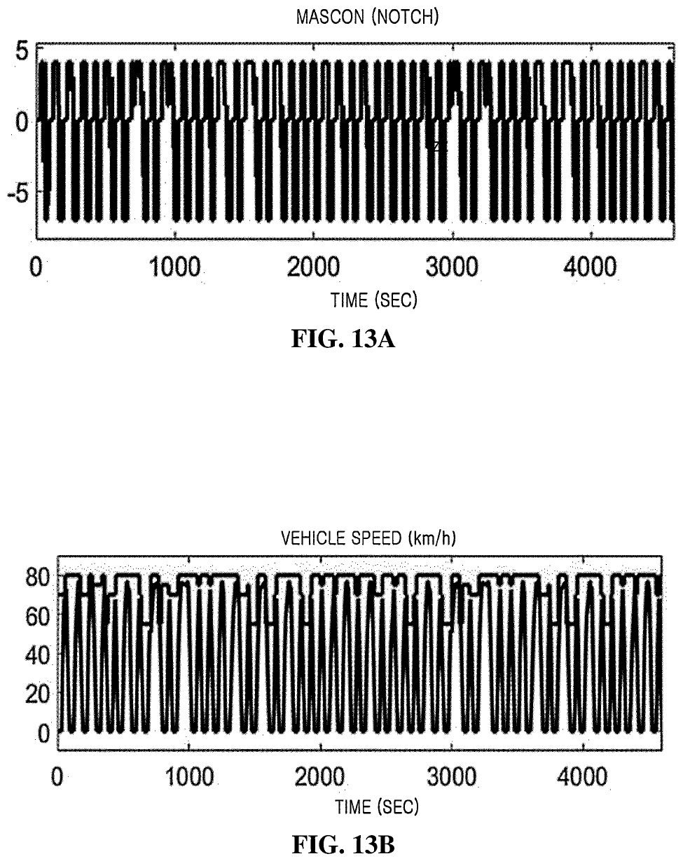

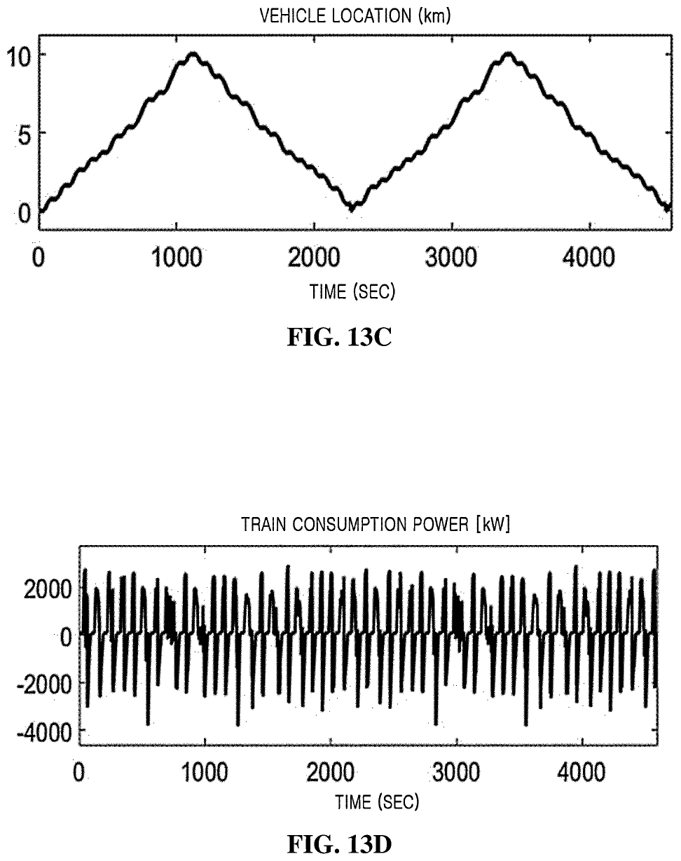

FIGS. 13A to 13D show the result of computation performed by the train operation model according to an embodiment of the present disclosure.

FIG. 13A illustrates the output of notch values calculated by the state machine along a temporal axis.

FIG. 13B illustrates the result of vehicle speed computation along a temporal axis.

FIG. 13C illustrates the location of a vehicle along a temporal axis.

FIG. 13D illustrates the result of train power consumption computation along a temporal axis.

Then, the power simulation process S830 performed by using state-space equations will be described.

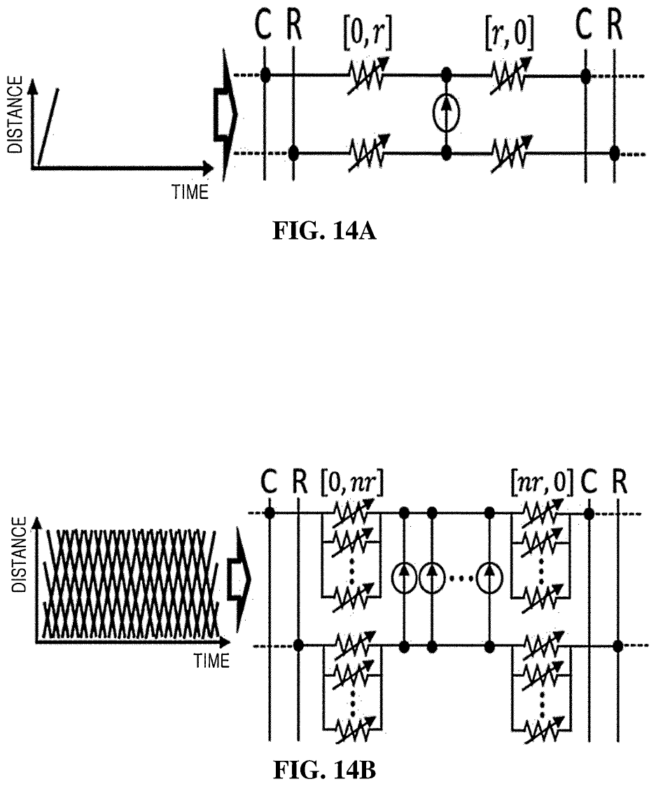

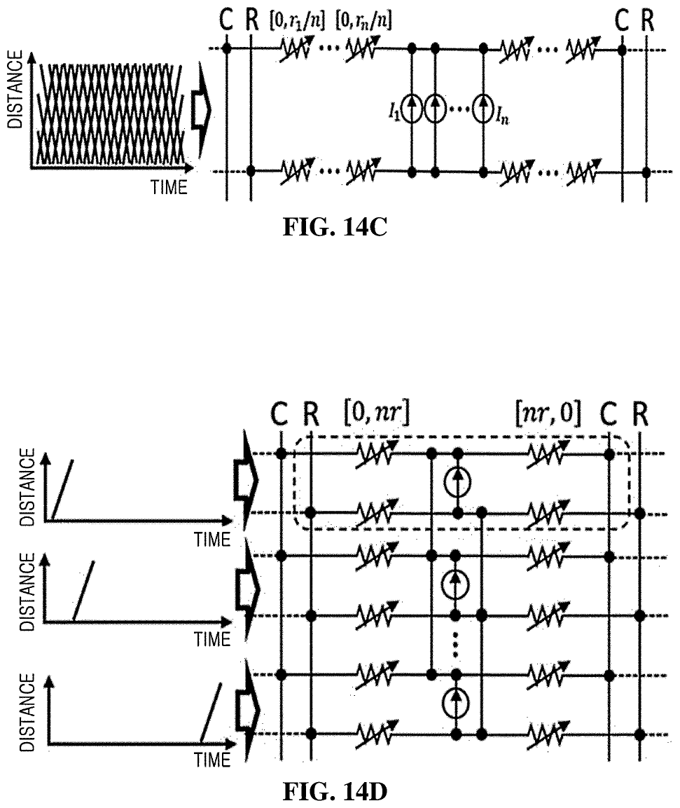

FIGS. 14A to 14D show examples of an equivalent model of the railway system used in the train operation model according to an embodiment of the present disclosure.

FIG. 14A shows a single train formation moving load model, FIG. 14B shows a parallel impedance configuration as a multi-train formation moving load model, FIG. 14C shows a series impedance configuration as a multi-train formation moving load model, and FIG. 14D shows the rearrangement and alignment of multi-train formation moving load models.

A configuration that does not use switches can be derived starting from a basic single train formation moving load model. First, when a single impedance is configured in parallel equivalent with identical impedances, the result becomes the product of N number of impedance values. Since vehicle loads (current sources) are also connected to the same node, they can be configured as parallel current sources. When they are rearranged and aligned, a train diagram can be easily applied thereto as shown in FIG. 14D.

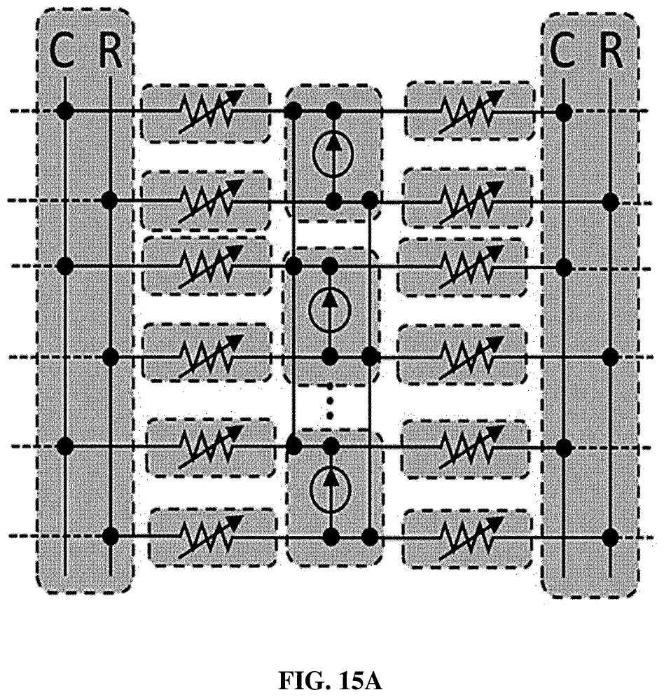

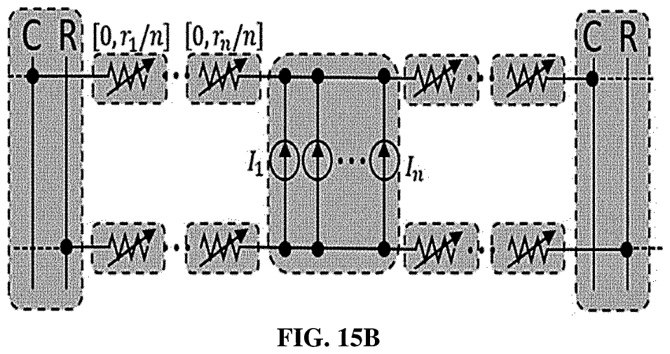

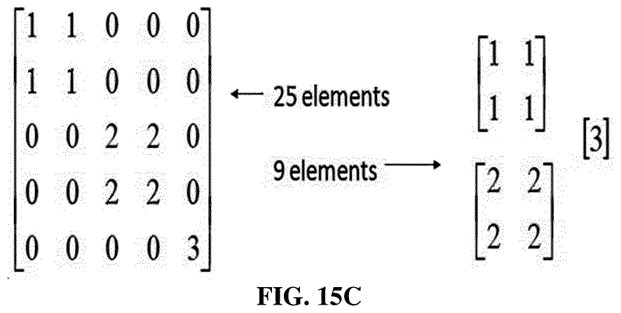

FIGS. 15A to 15C illustrate a process of analyzing the equivalent model of the railway system used in the train operation model according to an embodiment of the present disclosure.

In the multi-train formation moving load model shown in FIG. 14D, the model can be divided for each element. In each diagram, the resistance values are the same, and the trains have different operation time intervals and thus change in different patterns.

FIG. 15A shows a parallel configuration by applying the decomposition of a railway system model, FIG. 15B shows a series configuration by applying the decomposition of a railway vehicle model, and FIG. 15C shows a system decomposition method using model reduction techniques.

This equivalent model can be expressed in state-space equations to obtain a solution.

For example, matrices and vectors in the following form can be derived.

$${[ m \times 1 ]}^{\dot{x}} = {[ n \times n ]}^{A} \cdot {[ m \times 1 ]}^{x} + {[ m \times l ]}^{B} \cdot {[ l \times 1 ]}^{u}$$

$${[ p \times 1 ]}^{y} = {[ p \times m ]}^{C} \cdot {[ m \times 1 ]}^{x} + {[ p \times l ]}^{D} \cdot {[ l \times 1 ]}^{u}$$

Herein, the numbers of elements needed to configure a state-space matrix of a conventional DC railway system model as a single group include, for example, 37 inputs, 74 state values, 94 outputs, and 94 switches. To perform real-time computation, the scale of pre-calculated cache memory required by the simulator is at a level multiplied by 274, which makes memory storage impossible. Even if the number of switch contact points is reduced, it is difficult to perform a simulation with an approximately 50 us sampling rate.

$${[ 74 \times 1 ]}^{\dot{x}} = {[ 74 \times 74 ]}^{A} \cdot {[ 74 \times 1 ]}^{x} + {[ 74 \times 73 ]}^{B} \cdot {[ 73 \times 1 ]}^{u}$$

$${[ 130 \times 1 ]}^{y} = {[ 130 \times 74 ]}^{C} \cdot {[ 74 \times 1 ]}^{x} + {[ 130 \times 73 ]}^{D} \cdot {[ 73 \times 1 ]}^{u}$$

However, according to the method of the present disclosure, a storage capacity of cache memory prior to real-time computation is 393.626 MB. The entire computation group can be divided into 67 groups, and most of the groups consist only of input and output and the others consist of three substations each having 28 states, 35 inputs, 20 outputs, and 12 switches. All of the 12 switches correspond to 12 pulse diodes, and diodes are classified as switches and included in computation. However, the computational scale prior to real-time simulation is greatly reduced to 212*3 rather than twice the sum of 236 elements of the state-space matrix. Thus, the amount of computation required for input and output of the system model stored in the cache memory within the same time interval during real-time simulation is reduced, thereby ensuring real-time performance. However, the 12 diodes or switches in each substation may vary depending on the type of the substation. For example, a bidirectional converter thyristor converter includes 24 thyristors per substation.

### 2. Configuration of Converter Station Simulation Program

The DC/DC converter of the converter station model is composed of switching elements, inductors, capacitors, etc., and is implemented using component models provided by the real-time simulator. The DC/DC converter supplying power needed for train operation in the converter station can be configured as follows.

The configuration of the DC/DC converter can vary depending on whether the distribution system is a two-line or three-line system. In the case of a two-line distribution system, it consists of positive and negative poles, and when the distribution system has a voltage of +20 KV, the input of the DC/DC converter in the converter station can be configured with a voltage of 40 KV. The output will be at railway operating voltages of 3000 V, 1500 V, or 750 V. Assuming that the unit capacity of one converter station is 2 MW, two or three converter stations may need to be added in parallel in consideration of the largest capacity based on the time interval (schedule) or capacity of the operating vehicles. When converter stations are added in parallel, balancing control may be required within the converter stations.

In the case of a three-line distribution system, it consists of positive and negative poles and a neutral line. When the distribution system has a voltage of +20 KV, the DC/DC converter in the converter station can be configured with one converter connected to a positive pole and a neutral line with an input of 20 KV and another converter connected to a negative pole and a neutral line with an input of 20 KV. For the same converter topology as in the two-line case, two DC/DC converters, each with a 1 MW capacity, are required to meet the unit capacity of 2 MW in one converter station.

Further, two or three converter stations may need to be added in parallel in consideration of the largest capacity based on the time interval (schedule) or capacity of the operating vehicles. Even if converter stations are added in parallel, the overall balance can be maintained as each converter performs its own balancing control. This balancing control is performed by a control logic to select a reference voltage on the series configuration side, perform PI control to eliminate the error between the reference voltage and the actual measured voltage, and adjust the amount of power (P) to achieve balance. Desirably, the topology of the DC/DC converter may be designed considering the following railway characteristics.
Considering wide load variation range from light to medium loads (vehicle composition, operation time interval/speed, acceleration/deceleration, etc.) (maintaining high efficiency over wide load range)
Considering large moving loads (approximately 1 MW per M car)
Generation of regenerative energy (considering bidirectional power flow)
Application of isolation to separate from power system of KEPCO
Securing control stability through balancing control

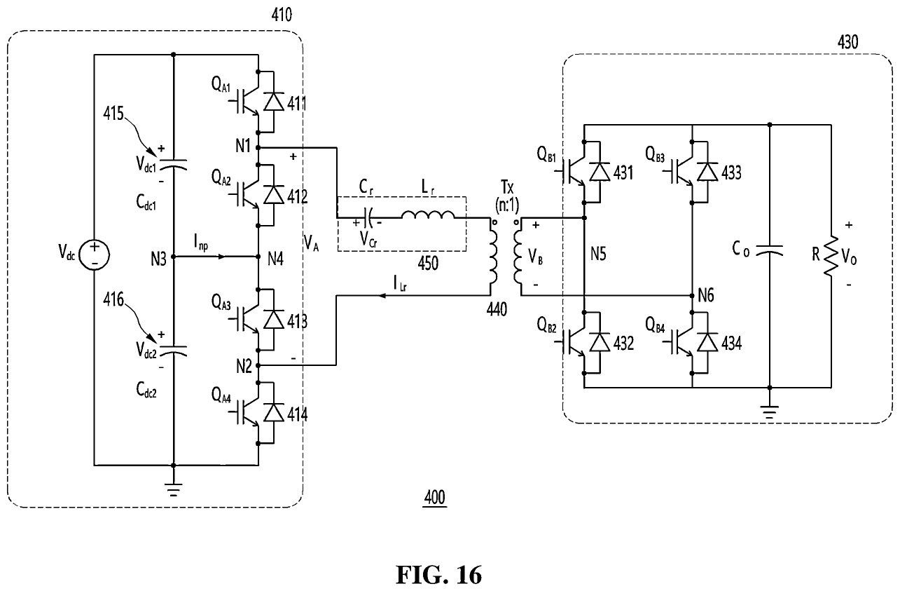

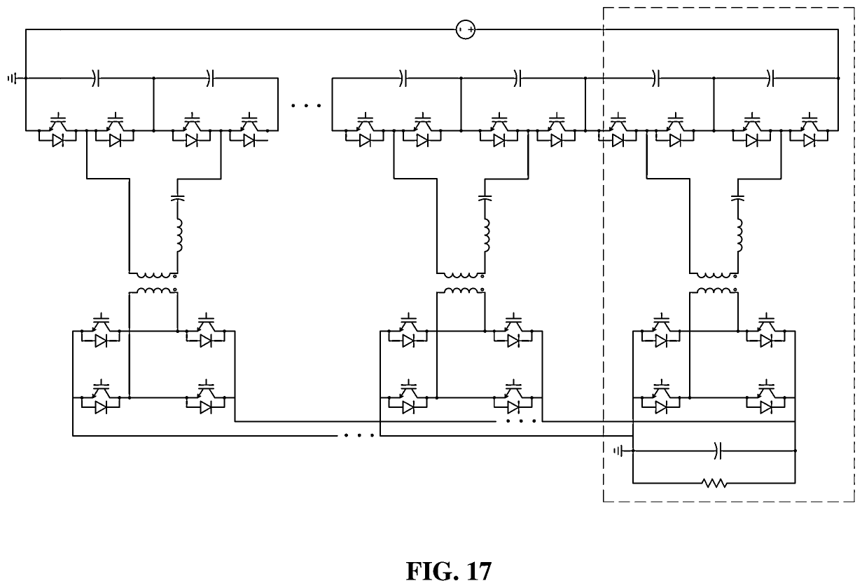

FIG. 16 illustrates an SRDAB converter applied to a converter station model according to an embodiment of the present disclosure, and FIG. 17 illustrates an Input-Series-Output-Parallel (ISOP) connection state of SRDAB converters applied to the converter station model according to an embodiment of the present disclosure.

First, referring to FIG. 16, the structure of a 2-series HB-based SRDAB converter as a DC/DC converter can be observed.

An SRDAB converter 400 includes an input circuit 410, an output circuit 430, a transformer 440, and a resonant circuit 450. The SRDAB converter 400 may be implemented by not only physical circuit elements but also software constituting the DC/DC converter in the converter station model.

The input circuit 410 includes a power supply, a first capacitor 415 and a second capacitor 416 connected in series with the power supply, and first to fourth switching elements 411, 412, 413 and 414 connected in series to the power supply along a half-bridge configuration. The first capacitor 415 is connected in parallel to the first switching element 411 and the second switching element 412, while the second capacitor 416 is connected in parallel to the third switching element 413 and the fourth switching element 414. A connection node N3 where the first capacitor 415 and the second capacitor 416 are connected and a connection node N4 where the second switching element 412 and the third switching element 413 are connected are connected to each other, and a neutral point current Inp flows between the connection node N3 and the connection node N4.

The resonant circuit 450 and the transformer 440 are coupled between the input circuit 410 and the output circuit 430. The resonant circuit 450 is coupled between a connection node N1 for the first switching element 411 and the second switching element 412 and a connection node N2 for the third switching element 413 and the fourth switching element 414, and may include a capacitor Cr and an inductor Lr connected in series to each other.

Additionally, the transformer 440 has one primary side end connected to an output end (an end of the inductor Lr) of the resonant circuit 450 and the other primary side end connected to the connection node N2.

The output circuit 430 includes a first switching element 431, a second switching element 432, a third switching element 433 and a fourth switching element 434 connected to each other along a full-bridge configuration. The output circuit 430 is connected to a secondary side of the transformer 440. The output circuit 430 includes one secondary end connected to a connection node N5 for the first switching element 431 and the second switching element 432 and the other secondary end connected to a connection node N6 for the third switching element 433 and the fourth switching element 434.

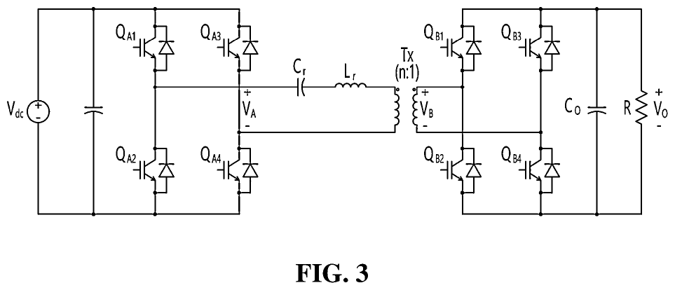

Unlike the converter shown in FIG. 3, the SRDAB converter according to the present disclosure has an input side configured in a 2-series half-bridge structure. Therefore, a switching rated voltage that each unit switch must withstand is equal to half of an input side power supply voltage, Vdc. As a result, it can be seen that the number of components required on the input side under the same rated voltage conditions is equal to half that of a full-bridge configuration.

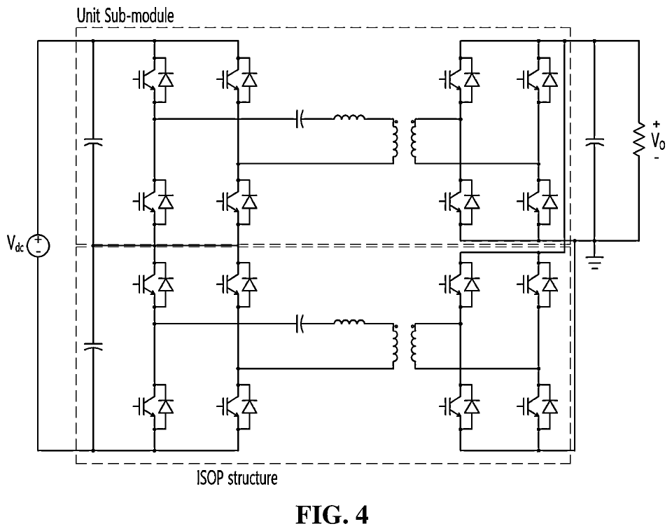

As shown in FIG. 17, the SRDAB converters can be expanded into an ISOP structure for application to MVDC. An input voltage for MVDC reaches tens of kilovolts, and if the SRDAB converters are configured to have a conventional full-bridge structure, the number of active and passive components greatly increases and separate control requirements for current balancing between the increased submodules increase. However, if the ISOP configuration is based on the half-bridge-based SRDAB converters proposed in the present disclosure, the number of active and passive components is reduced by half and a controller for current balancing is reduced in configuration by half and thus simplified. That is, in the circuit having the conventional 2-level FB structure as shown in FIG. 4, a switching rated voltage of a unit switch is Vdc, whereas a switching rated voltage of a unit switch based on HB according to the proposed method in FIG. 17 is 0.5 Vdc. Therefore, according to the present disclosure, it can be expected that the number of passive components is reduced by half under the same switching rated voltage conditions.

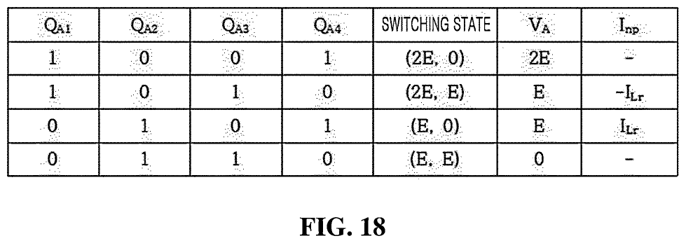

FIG. 18 is provided to explain an operation of the SRDAB converter according to an embodiment of the present disclosure.

Specifically, FIG. 18 shows output leg voltages and neutral point (NP) currents based on the switching states of the input circuit. A first switching element (QA1) 411 and a second switching element (QA2) 412 operate complementarily to each other, and a third switching element (QA3) 413 and a fourth switching element (QA4) 414 operate complementarily to each other. A primary side leg voltage VA, which is a voltage between the connection node N1 and the connection node N2, can be output as a three-step voltage, 0, E, and 2E. Herein, E refers to a unit voltage of capacitors Cdc1 and Cdc2.

Also, it can be seen that the neutral point current Inp between the connection node N3 and the connection node N4 is either ILr or −ILr depending on the switching state of the circuit when VA is equal to E. Herein, it can be seen that the neutral point current is related to the direction of a resonant current.

Since the converter 400 of the present disclosure also includes two input capacitors 415 and 416 connected in series to each other, careful control is required to suppress a voltage difference between the capacitors. To this end, the present disclosure employs a new switching sequence, which eliminates the need for an additional controller.

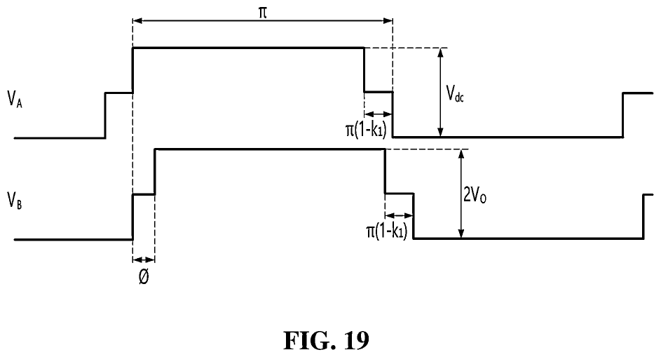

FIG. 19 shows primary and secondary side leg voltage waveforms of the SRDAB converter according to an embodiment of the present disclosure.

As described above, the primary side leg voltage VA is the voltage between the connection node N1 and the connection node N2, while a secondary side leg voltage VB is a voltage between the connection node N5 and the connection node N6. To control voltage balancing between the capacitors, the E level is essential, and the voltage is designed to have overall three steps of 0->E->2E. This control method can be helpful in achieving Zero Voltage Switching (ZVS) for the secondary side switches.

The duration of the E voltage level is represented by π(1−k₁), and the primary side leg voltage VA and the secondary side leg voltage VB have a phase difference of φ. Herein, k₁ is a modulation index ranging from 0 to 1. According to the present disclosure, k₁ is fixed (e.g., at 0.9), and an output voltage is controlled by the phase difference φ. An output power Po and an output voltage Vo are both smoothly adjusted in proportion to the phase difference sin φ.

The following Equations 3 to 5 represent a relationship between the output power Po and the output voltage Vo of the converter according to the present disclosure. X represents an equivalent impedance of the resonant circuit (Lr−Cr) 450 at a switching frequency ωsw. Herein, ωr corresponds to a resonant frequency of the resonant circuit 450, and R represents an output resistance.

$${P}_{O} = \frac{4 {V}_{dc} {V}_{O}}{{π}^{2} X} {( sin \frac{π}{2} {k}_{1} )}^{2} sin ϕ \qquad [ Equation 3 ]$$

$${V}_{O} = \frac{4 {RV}_{dc}}{{π}^{2} X} {( sin \frac{π}{2} {k}_{1} )}^{2} sin ϕ \qquad [ Equation 4 ]$$

$$X = {ω}_{sw} {L}_{r} ( 1 - {( \frac{{ω}_{r}}{{ω}_{sw}} )}^{2} ) , \qquad [ Equation 5 ]$$

$${ω}_{r} = \frac{1}{\sqrt{{L}_{r} {C}_{r}}} .$$

Hereafter, a switching sequence for driving the SRDAB converter according to the present disclosure will be described.

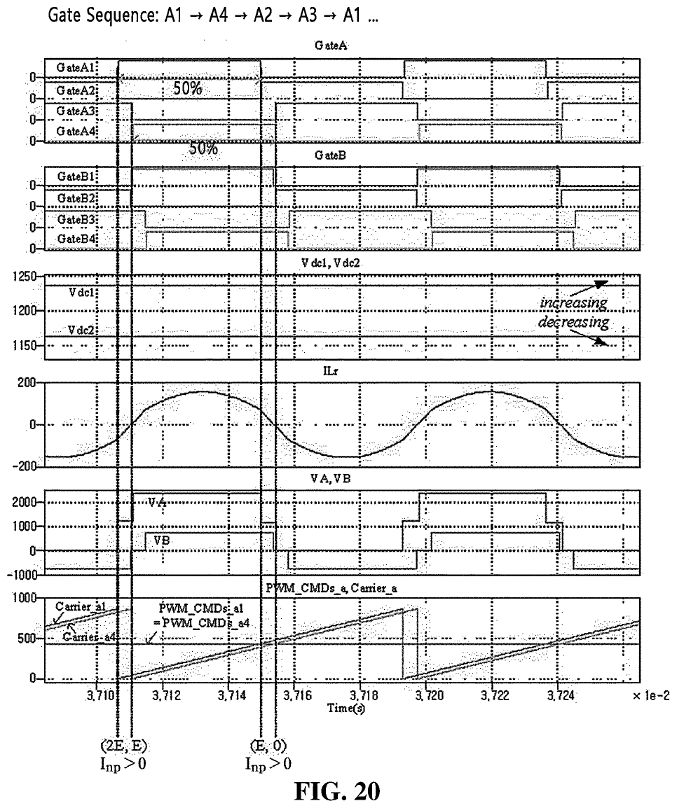

FIG. 20 shows a case where a switching sequence based on a typical phase shifting technique is applied to the present disclosure.

A switching method based on typical phase shifting adjusts a gate to control the turn-on/turn-off timing in the sequence of A1->A4->A2->A3->A1-> . . . with a 50% duty signal as shown in FIG. 20. According to this phase shifting technique, as shown in FIG. 20, in switching pairs (2E, E) and (E, 0) constituting E levels, Inp becomes positive in all cases, causing Cdc1 to keep being charged and Cdc2 to keep being discharged. Thus, it is difficult to achieve voltage balancing. This is because not all switching patterns that express E levels are utilized. To solve this, the present disclosure proposes a new switching sequence through the modulation of voltage magnitude and the application of clamping mode.

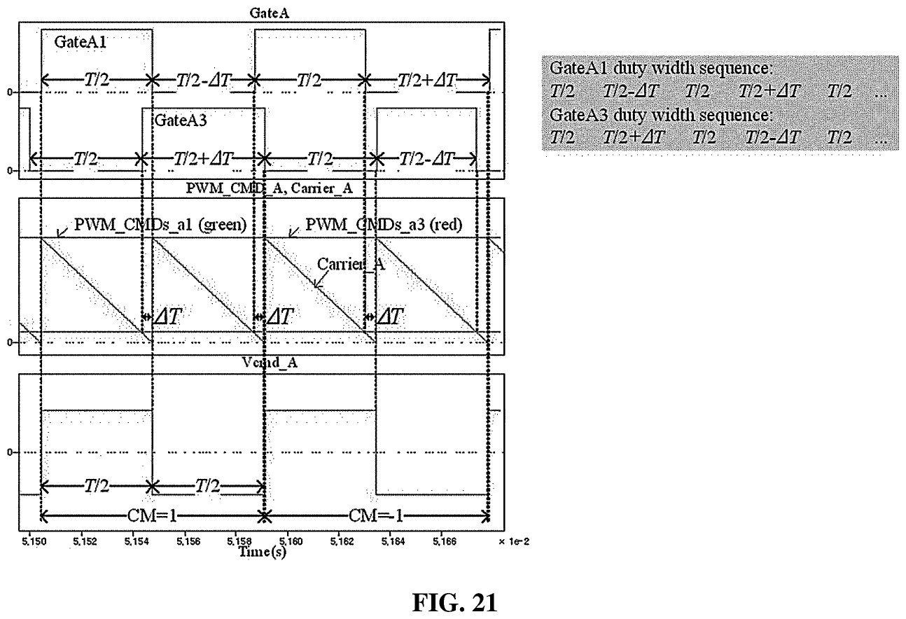

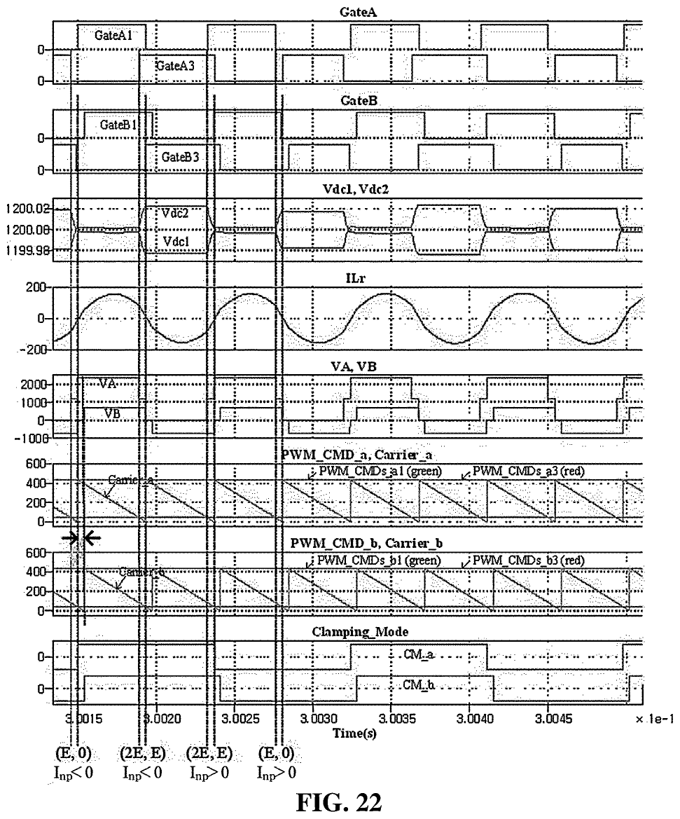

FIG. 21 and FIG. 22 show switching sequences based on pulse amplitude modulation for driving the SRDAB converter according to the present disclosure.

In the following drawings, each of Gate A, Carrier A, Vampl_a, Vcmd_a, etc. refer to a signal on the primary side or input circuit 410 side of the transformer 440, while each of Gate B, Carrier B, Vampl_b, Vcmd_b, etc. refers to a signal on the secondary side or output circuit 430 side of the transformer 440.

In a first switching sequence applied to the first switching element (GateA1) 411, a first pulse with a pulse width for a reference time T/2 and an amplitude of a first level, a second pulse with a pulse width for a time T/2−ΔT obtained by subtracting a predetermined period of time from the reference time and an amplitude of a second level, a third pulse with a pulse width for the reference time T/2 and an amplitude of the first level, and a fourth pulse with a pulse width for a time T/2+ΔT obtained by adding a predetermined period of time to the reference time and an amplitude of the second level are repeated periodically.

Similarly, in a second switching sequence applied to the third switching element (GateA3) 413, a first pulse with a pulse width for the reference time T/2 and an amplitude of the second level, a second pulse with a pulse width for the time T/2+ΔT obtained by adding a predetermined period of time to the reference time and an amplitude of the first level, a third pulse with a pulse width for the reference time T/2 and an amplitude of the second level, and a fourth pulse with a pulse width for the time T/2−ΔT obtained by subtracting a predetermined period of time from the reference time and an amplitude of the first level are repeated periodically. Herein, the first level is a high level, and the second level, which differs from the first level, is a low level.

That is, the first switching element (GateA1) 411 is switched on and off for T/2->T/2−ΔT->T/2->T/2+ΔT->T/2-> . . . , while the third switching element (GateA3) 413 is switched on and off for T/2->T/2+ΔT->T/2->T/2−ΔT->T/2-> . . . , which allows both positive and negative polarities of the neutral point current to be used. Therefore, voltage balancing for the input capacitors can be naturally achieved. Meanwhile, the second switching element (GateA2) 412 and the fourth switching element (GateA4) 414 have complementary characteristics and thus their switching sequences are determined to be the opposite of the first switching element (GateA1) 411 and the third switching element (GateA3) 413, respectively.

As shown in FIG. 22, in the switching pairs (E, 0) and (2E, E) constituting E levels, both positive and negative periods of neutral point current Inp exist, which allows Cdc1 and Cdc2 to be alternately charged and discharged. As a result, it can be seen that a voltage Vdc1 of Cdc1 and a voltage Vdc2 of Cdc2 rise and fall alternately, which enables voltage balancing between the capacitors.

Accordingly, during one cycle of the first switching sequence and the second switching sequence, a first neutral point current Inp includes both negative and positive periods.

In this case, the first pulse of the first switching sequence has the same pulse width as the first pulse of the second switching sequence, but the first pulse of the second switching sequence is placed earlier by a predetermined period of time ΔT. That is, a rising edge of the first pulse of the first switching sequence is placed later by the predetermined period of time ΔT than a falling edge of the first pulse of the second switching sequence.

Also, a pulse width of the second pulse of the first switching sequence is set to T/2−ΔT, and a pulse width of the second pulse of the second switching sequence is set to T/2+ΔT. A rising edge of the second pulse of the second switching sequence is placed earlier by the predetermined period of time ΔT than a falling edge of the first pulse of the first switching sequence, and a falling edge of the second pulse of the second switching sequence is placed later by the predetermined period of time ΔT than a rising edge of the second pulse of the first switching sequence.

Further, the third pulse of the first switching sequence has the same pulse width as the third pulse of the second switching sequence, but a rising edge of the third pulse of the first switching sequence is placed earlier by the predetermined period of time ΔT than a falling edge of the third pulse of the second switching sequence. Initially, the second switching sequence is placed earlier by the predetermined period of time ΔT, but during an operation of the second pulse, the pulse width of the second pulse of the second switching sequence is set to be extended by twice the predetermined period of time (2ΔT), which causes the third pulse of the second switching sequence to be delayed by the predetermined period of time ΔT.

Furthermore, a pulse width of the fourth pulse of the first switching sequence is set to T/2+ΔT, and a pulse width of the fourth pulse of the second switching sequence is set to T/2−ΔT. A falling edge of the fourth pulse of the first switching sequence is placed earlier by the predetermined period of time ΔT than a rising edge of the fourth pulse of the second switching sequence, and a rising edge of the fourth pulse of the first switching sequence is placed later by the predetermined period of time ΔT than a falling edge of the fourth pulse of the second switching sequence.

With this configuration, a negative neutral point current Inp flows for a time interval ΔT between the falling edge of the first pulse of the second switching sequence and the rising edge of the first pulse of the first switching sequence, and a negative neutral point current Inp also flows for a time interval ΔT between the rising edge of the second pulse of the second switching sequence and the falling edge of the second pulse of the first switching sequence.

Also, a positive neutral point current Inp flows for a time interval ΔT between the rising edge of the third pulse of the first switching sequence and the falling edge of the third pulse of the second switching sequence, and a positive neutral point current Inp also flows for a time interval ΔT between the falling edge of the fourth pulse of the first switching sequence and the rising edge of the fourth pulse of the second switching sequence.

Meanwhile, FIG. 21 illustrates a switching pattern design according to a proposed pulse magnitude modulation method. Herein, Vcmd_A represents a command voltage with an amplitude alternating by ±Vampl_a every half cycle, and a clamping mode CM operates at 1 during a first cycle and at −1 during the next cycle.

A carrier wave is a down-counting triangle wave, and command values Vcmd_a1 and Vcmd_a3 for the first switching element (QA1) 411 and the third switching element (QA3) 413 are set based on CM as follows.

In case of CM=1, Vcmd_a1 has a value 0.5 Vcmd_a and Vcmd_a3 has a value −0.5 Vcmd_a. Then, an offset voltage Voffset is set to Vdc_ref/4−max (Vcmd_a1, Vcmd_a3). Herein, max(a, b) is a function that outputs the larger of two values a and b.

In case of CM=−1, polarities of Vcmd_a1 and Vcmd_a3 are set to be reversed from those in case of CM=1 and an offset voltage Voffset is calculated in the same manner. Then, the offset voltage and Vdc_ref/4 are added to the original command values Vcmd_a1 and Vcmd_a3 to calculate PWM command values. Thereafter, these values are divided by Vdc_ref/2 and multiplied by N_max to calculate final normalized PWM command values for comparison with a triangular carrier wave.

By calculating the PWM command values according to CM as described above, a special switching sequence illustrated in FIG. 21 can be expressed. The first switching element (GateA1) is switched on and off for T/2->T/2−ΔT->T/2->T/2+ΔT->T/2-> . . . , while the third switching element GateA3 is switched on and off for T/2->T/2+ΔT->T/2->T/2−ΔT->T/2-> . . . . Such a special switching pattern uses both positive and negative polarities of the neutral point current to naturally achieve input capacitor voltage balancing.

FIG. 22 shows key waveforms from a simulation of the SRDAB converter. PWM_CMD_a1 determines on/off of GateA1 by comparing it with a primary side carrier wave, and PWM_CMD_a3 determines on/off of GateA3 by comparing it with the primary side carrier wave. Meanwhile, the second switching element (GateA2) 412 and the fourth switching element (GateA2) 414 have complementary characteristics and thus their switching sequences are determined to be the opposite of the first switching element (GateA1) 411 and the third switching element (GateA3) 413, respectively. While the typical phase-shift method shown in FIG. 20 only uses the positive values of the neutral point current Inp, both positive and negative values of the neutral point current Inp can be used in this case. Thus, a voltage difference between the input capacitors can be naturally eliminated. It can be seen that both positive and negative values of the neutral point current Inp are used in case of CM=1 or CM=−1, and, thus, a voltage difference between the capacitors can be eliminated.

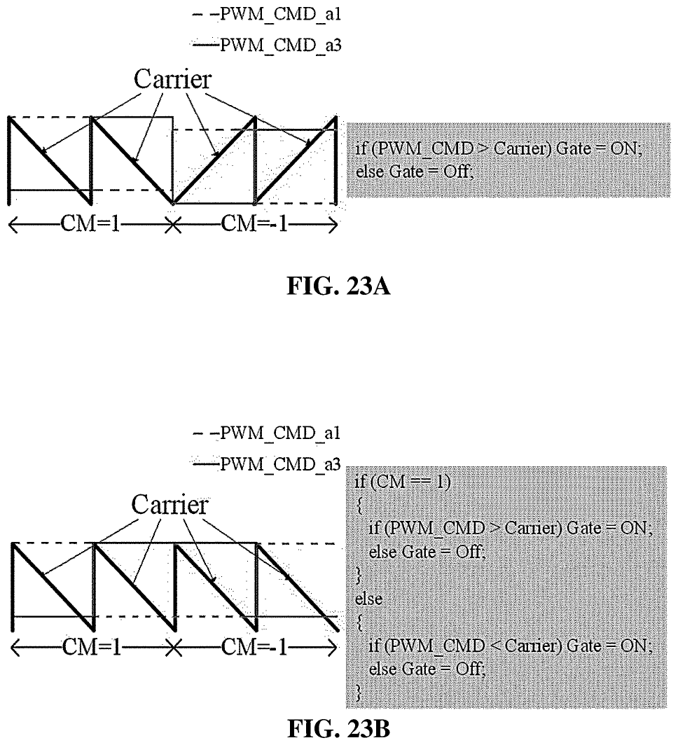

FIGS. 23A and 23B show a relationship between a carrier and a pulse-width modulation (PWM) command value in a method of driving the SRDAB converter according to an embodiment of the present disclosure.

In order to output a symmetric leg waveform, an initial value and a counting direction of a carrier are made opposite depending on CM (see FIG. 23A). During a period in which a PWM command value PWM−CMD is greater than the carrier, a signal GateA or GateB is output to turn on the corresponding switch, and during the remaining period, a signal is output to turn off the corresponding switch as shown in FIGS. 21 and 22. In case of FIG. 23A, since PWM_CMD_a1 (dotted signal) is greater than the carrier during a first pulse period of the carrier, a signal GateA1 is output to turn on the first switching element 411. Further, during a period in which PWM_CMD_a2 (solid signal) is temporarily greater than the carrier, a signal GateA3 is output to turn on the third switching element 413.

On the other hand, a method can be implemented where the carrier remains unchanged but a relationship between the command value and the carrier is applied in reverse depending on CM (see FIG. 23B). This approach may be more suitable for utilizing a phase difference between the primary and secondary sides. That is, in case of CM=−1, a signal GateA or GateB is output to turn on the corresponding switch during a period in which the PWM command value PWM−CMD is smaller than the carrier, and a signal is output to turn off the switch during the remaining period.

When an offset voltage Voffset is calculated, Voffset ordinarily needs to be equal to Vdc_ref/4-min (Vcmd_a1, Vcmd_a3) in case of CM=−1, but if the method shown in FIG. 23B is adopted, the same effect can be achieved by setting a maximum value instead of a min value in case of CM=−1 and reversing the polarities of Vcmd_a1 and Vcmd_a3.

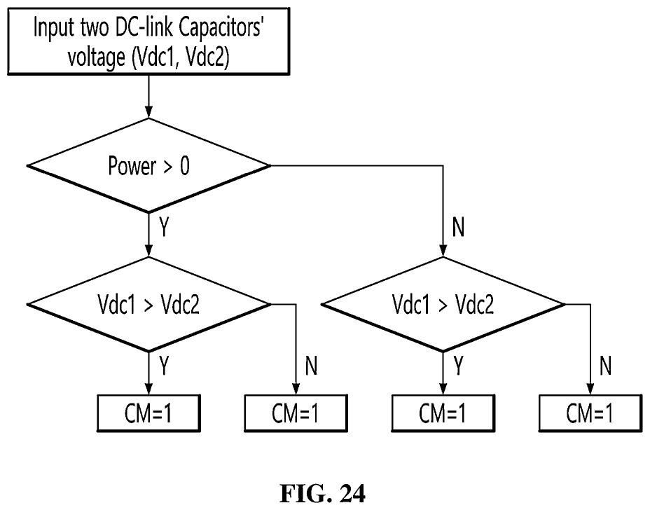

FIG. 24 shows a process of selecting a command mode CM in the method of driving the SRDAB converter according to an embodiment of the present disclosure.

By receiving the voltages Vdc1 and Vdc2 of the input capacitors, the direction of power flow (positive: power flows from the source to the load, negative: power flows from the load to the source) is determined, and the command mode CM is determined based a relative magnitude between the voltage Vdc1 of the first capacitor and the voltage Vdc2 of the second capacitor. For example, if power flows from the source to the load, CM becomes 1 when the voltage Vdc1 of the first capacitor is greater than the voltage Vdc2 of the second capacitor, and CM becomes −1 when the voltage Vdc1 of the first capacitor is smaller than the voltage Vdc2 of the second capacitor. Also, if power flows from the load to the source, CM becomes −1 when the voltage Vdc1of the first capacitor is greater than the voltage Vdc2 of the second capacitor, and CM becomes 1 when the voltage Vdc1 of the first capacitor is smaller than the voltage Vdc2 of the second capacitor.

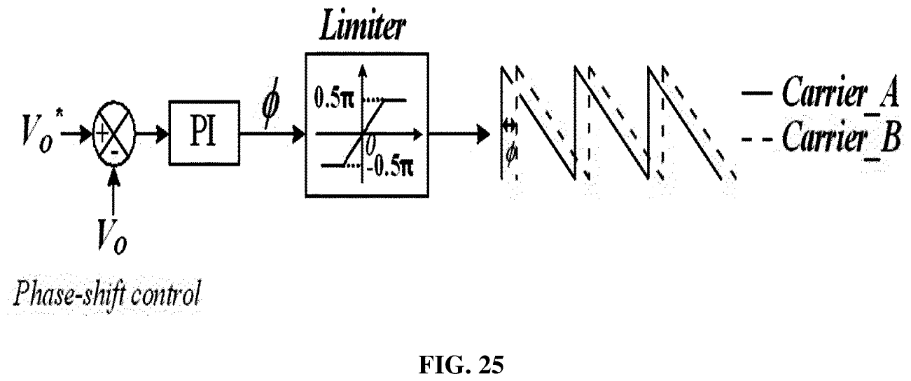

FIG. 25 to FIG. 27 are block diagrams of a control logic that outputs control signals for the SRDAB converter according to an embodiment of the present disclosure.

The illustrated control logic may be implemented by the converter controller 300 in the form of hardware.

First, FIG. 25 illustrates a control logic that determines a phase difference between the primary and secondary sides of the transformers, or between the input and output circuits.

A difference between output value Vo and an initial value Vo* of the SRDAB converter is integrated through a PI controller to determine a phase difference and set upper and lower limits. Through this process, a primary side carrier Carrier_A and a secondary side carrier Carrier_B are output.

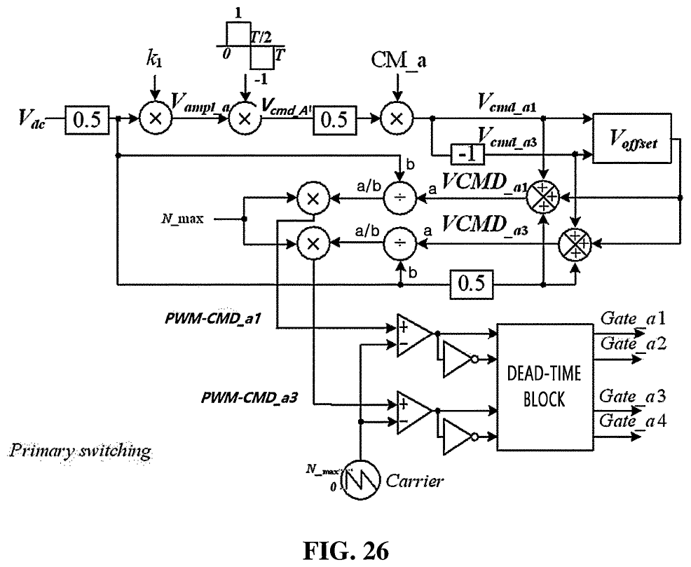

FIG. 26 illustrates a control logic that outputs a switching sequence on the primary side or input circuit side.

As described above with reference to FIG. 21, Vcmd_A represents a command voltage with an amplitude alternating by +Vampl_a every half cycle. The offset voltage Voffset is determined depending on the clamping mode.

In case of CM=1, Vcmd_a1 has a value of 0.5 Vcmd_A and Vcmd_a3 has a value of −0.5 Vcmd_A. The offset voltage is then calculated as 0.25*Vdc-max(Vcmd_a1, Vcmd_a3) based on CM_a, Vcmd_a1, and Vcmd_a3. This offset voltage is equally added to the original command values Vcmd_a1 and Vcmd_a3 to be calculated as VCMD_a1 and VCMD_a3, respectively. Herein, max(a, b) is a function that outputs the larger of two values a and b. The values obtained by dividing VCMD_a1 and VCMD_a3 by 0.5*Vdc for normalization and multiplying by N_max are output as PWM command values PWM_CMD_a1 and PWM_CMD_a3.

In case of CM=−1, polarities of Vcmd_a1 and Vcmd_a3 are set to be reversed from those in case of CM=1 (Vcmd_a1 =−0.5 Vcmd_A, Vcmd_a3=0.5 Vcmd_A) and an offset voltage is calculated in the same manner. Then, the offset voltage is equally added to the original command values Vcmd_a1 and Vcmd_a3 to calculate VCMD_a1 and VCMD_a3. Finally, the values are normalized by dividing by 0.5 Vdc and then multiplied by N_max to calculate final PWM command values PWM_CMD_a1 and PWM_CMD_a3 for comparison with a triangular carrier wave.

A dead-time block ensures that the first switching element 411 and the second switching element 412 do not turn on simultaneously, but operate complementarily to each other and the third switching element 413 and the fourth switching element 414 do not turn on simultaneously, but operate complementarily to each other.

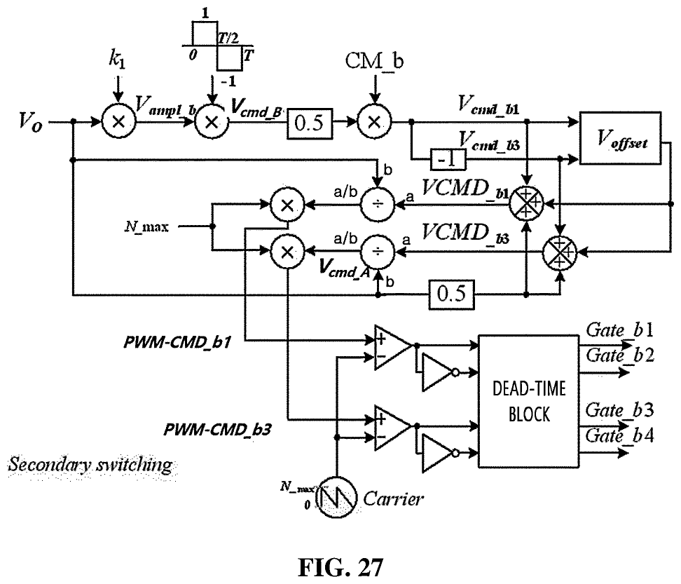

FIG. 27 illustrates a control logic that outputs a switching sequence on the secondary side or output circuit side.

The operation on the secondary side will be described in more detail. Vcmd_B represents a command voltage with an amplitude alternating by +Vampl_b every half cycle. The offset voltage Voffset is determined depending on the clamping mode.

b In case of CM=1, Vcmd_b1 has a value of 0.5 Vcmd_B and Vcmd_b3 has a value of −0.5 Vcmd_B. The offset voltage is then calculated as 0.5*Vo−max(Vcmd_b1, Vcmd_b3) based on CM_b, Vcmd_b1, and Vcmd_b3. This offset voltage is equally added to the original command values Vcmd_b1 and Vcmd_b3 to be calculated as VCMD_b1 and VCMD_b3, respectively. The values obtained by dividing VCMD_b1 and VCMD_b3 by Vo for normalization and multiplying by N_max are output as PWM command values PWM_CMD_b1 and PWM_CMD_b3.

In case of CM=−1, polarities of Vcmd_b1 and Vcmd_b3 are set to be reversed from those in case of CM=1 (Vcmd_b1=−0.5*Vcmd_B, Vcmd_b3=0.5*Vcmd_B) and an offset voltage is calculated in the same manner. Then, the offset voltage is equally added to the original command values Vcmd_b1 and Vcmd_b3 to calculate VCMD_b1 and VCMD_b3. Finally, the values are normalized by dividing by Vo and then multiplied by N_max to calculate final PWM command values PWM_CMD_b1 and PWM_CMD_b3 for comparison with a triangular carrier wave.

A dead-time block ensures that the first switching element 431 and the second switching element 432 do not turn on simultaneously, but operate complementarily to each other, and the third switching element 433 and the fourth switching element 434 do not turn on simultaneously, but operate complementarily to each other.

The embodiment of the present disclosure can be embodied in a storage medium including instruction codes executable by a computer such as a program module executed by the computer. A computer-readable medium can be any usable medium which can be accessed by the computer and includes all volatile/non-volatile and removable/non-removable media. Further, the computer-readable medium may include all computer storage media. The computer storage media include all volatile/non-volatile and removable/non-removable media embodied by a certain method or technology for storing information such as computer-readable instruction code, a data structure, a program module or other data.

The method and system of the present disclosure have been explained in relation to a specific embodiment, but their components or a part or all of their operations can be embodied by using a computer system having general-purpose hardware architecture.

The above description of the present disclosure is provided for the purpose of illustration, and it would be understood by a person with ordinary skill in the art that various changes and modifications may be made without changing technical conception and essential features of the present disclosure. Thus, it is clear that the above-described examples are illustrative in all aspects and do not limit the present disclosure. For example, each component described to be of a single type can be implemented in a distributed manner. Likewise, components described to be distributed can be implemented in a combined manner.

The scope of the present disclosure is defined by the following claims rather than by the detailed description of the embodiment. It shall be understood that all modifications and embodiments conceived from the meaning and scope of the claims and their equivalents are included in the scope of the present disclosure.

### EXPLANATION OF CODES

100: Modeling device of DC railway system
110: Processor
120: Memory
130: Communication module
140: Database

1. A simulation system of a railway system for a Medium-Voltage Direct Current (MVDC) distribution network, comprising:
a computing device which stores a simulation program including a converter station model configured to simulate a converter station included in the MVDC distribution network and a train operation model configured to simulate an operation state of a train that is supplied with power from the converter station and runs;
a converter controller which controls a DC/DC converter included in the converter station model; and
a Hardware In the Loop Simulation (HILS) device which performs a simulation based on the converter station model, the train operation model, and the converter controller,
wherein the converter station model and the train operation model are executed in software by the HILS device, and the converter controller is connected to the HILS device and driven to control the converter station model.

2. The simulation system of a railway system of claim 1,
wherein the simulation program performs a train operation simulation based on a stream processing method by using the train operation model, and
the train operation model is configured to calculate an acceleration of the train based on a traction force and a running resistance or a braking force and a running resistance of the train, calculate a speed and a location by using the calculated acceleration and a time interval of a discrete-time system, output a notch value and a train power consumption value by performing train operation computation based on a state machine-based stream processing method using the speed and the location, input the train power consumption value converted as a current source to an equivalent model, calculate a coefficient matrix through state-space equations representing the equivalent model, and perform a power simulation by outputting the discrete-time system through calculation of the state-space equations.

3. The simulation system of a railway system of claim 2,
wherein the train operation model inputs the speed to the state machine consisting of a stop state, an acceleration state, a coasting state, and a braking state of the train, transitions the states of the state machine based on whether the speed reaches a speed limit, and outputs notch values matched with the respective states.

4. The simulation system of a railway system of claim 2,
wherein the train operation model outputs a traction force or a braking force corresponding to the speed and outputs a running resistance corresponding to the speed, and
the train operation model calculates the acceleration and the train power consumption value of the train based on the notch value output by the state machine depending on the speed, the traction force or the braking force, the running resistance, and a gradient resistance or a curve resistance corresponding to the location of the train.

5. The simulation system of a railway system of claim 1,
wherein the converter station model uses a Series-Resonant DAB (SRDAB) converter as a DC/DC converter, and
the SRDAB converter includes:
an input circuit including a first switching element, a second switching element, a third switching element and a fourth switching element connected in series to each other along a half-bridge configuration, a first capacitor connected in parallel to the first switching element and the second switching element, and a second capacitor connected in parallel to the third switching element and the fourth switching element;
an output circuit including a first switching element, a second switching element, a third switching element and a fourth switching element connected to each other along a full-bridge configuration; and
a resonant circuit and a transformer connected between the input circuit and the output circuit.

6. The simulation system of a railway system of claim 1,
wherein the converter station model uses a plurality of SRDAB converters connected in a Input-Series-Output-Parallel (ISOP) configuration as a DC/DC converter, and
each of the of SRDAB converters includes:
an input circuit including a first switching element, a second switching element, a third switching element and a fourth switching element connected in series to each other along a half-bridge configuration, a first capacitor connected in parallel to the first switching element and the second switching element, and a second capacitor connected in parallel to the third switching element and the fourth switching element;
an output circuit including a first switching element, a second switching element, a third switching element and a fourth switching element connected to each other along a full-bridge configuration; and
a resonant circuit and a transformer connected between the input circuit and the output circuit.

7. The simulation system of a railway system of claim 5,
wherein the resonant circuit and the transformer are connected to each other between a connection node for the first switching element and the second switching element of the input circuit and a connection node for the third switching element and the fourth switching element of the input circuit,
the resonant circuit includes a capacitor and an inductor connected in series to each other,
one primary side end of the transformer is connected to the resonant circuit and the other primary side end is connected to the connection node for the third switching element and the fourth switching element of the input circuit, and
one secondary side end of the transformer is connected to a connection node for the first switching element and the second switching element of the output circuit and the other secondary side end is connected to a connection node for the third switching element and the fourth switching element of the output circuit.

8. The simulation system of a railway system of claim 5,
wherein the converter controller includes a control logic configured to complementarily apply a first switching sequence to the first switching element and the second switching element of the input circuit and complementarily apply a second switching sequence to the third switching element and the fourth switching element of the input circuit, and
in the first switching sequence, a first pulse with a pulse width for a reference time T/2 and an amplitude of a first level, a second pulse with a pulse width for a time T/2−ΔT obtained by subtracting a predetermined period of time from the reference time and an amplitude of a second level, a third pulse with a pulse width for the reference time T/2 and an amplitude of the first level, and a fourth pulse with a pulse width for a time T/2+ΔT obtained by adding a predetermined period of time to the reference time and an amplitude of the second level are repeated periodically, and
in the second switching sequence, a first pulse with a pulse width for the reference time T/2 and an amplitude of the second level, a second pulse with a pulse width for the time T/2+ΔT obtained by adding a predetermined period of time to the reference time and an amplitude of the first level, a third pulse with a pulse width for the reference time T/2 and an amplitude of the second level, and a fourth pulse with a pulse width for the time T/2-AT obtained by subtracting a predetermined period of time from the reference time and an amplitude of the first level are repeated periodically, and
the first level is a high level, and the second level, which differs from the first level, is a low level.

9. A method of simulating a railway system for a Medium-Voltage Direct Current (MVDC) distribution network, comprising:
(a) executing a simulation program, which includes a converter station model configured to simulate a converter station included in the MVDC distribution network and a train operation model configured to simulate an operation state of a train that is supplied with power from the converter station and runs, in software by an HILS device; and
(b) driving the converter controller to control the converter station model by connecting a converter controller, which controls a DC/DC converter included in the converter station model, to the HILS device.

10. The method of simulating a railway system of claim 9,
wherein the process (a) includes performing a train operation simulation based on a stream processing method by using the train operation model, and
wherein the process of performing a train operation simulation includes:
(a-1) calculating an acceleration of the train based on a traction force and a running resistance or a braking force and a running resistance of the train;
(a-2) calculating a speed and a location by using the calculated acceleration and a time interval of a discrete-time system;
(a-3) outputting a notch value and a train power consumption value by performing train operation computation based on a state machine-based stream processing method using the speed and the location;
(a-4) inputting the train power consumption value converted as a current source to an equivalent model;
(a-5) calculating a coefficient matrix through state-space equations representing the equivalent model; and
(a-6) of performing power simulation by outputting the discrete-time system through calculation of the state-space equations.

11. The method of simulating a railway system of claim 10,
wherein the process (a-3) involves outputting notch values matched with the respective states by inputting the speed to the state machine consisting of a stop state, an acceleration state, a coasting state, and a braking state of the train, and transitioning the states of the state machine based on whether the speed reaches a speed limit.

12. The method of simulating a railway system of claim 10,
wherein the process (a-3) involves:
outputting a traction force or a braking force corresponding to the speed and outputting a running resistance corresponding to the speed; and
calculating the acceleration and the train power consumption value of the train based on the notch value output by the state machine depending on the speed, the traction force or the braking force, the running resistance, and a gradient resistance or a curve resistance corresponding to the location of the train.

13. The method of simulating a railway system of claim 9,
wherein in the process (a), executing a simulation program using the converter station model in software by the HILS device,
the converter station model uses an SRDAB converter as a DC/DC converter, and
the SRDAB converter includes:
an input circuit including a first switching element, a second switching element, a third switching element and a fourth switching element connected in series to each other along a half-bridge configuration, a first capacitor connected in parallel to the first switching element and the second switching element, and a second capacitor connected in parallel to the third switching element and the fourth switching element;
an output circuit including a first switching element, a second switching element, a third switching element and a fourth switching element connected to each other along a full-bridge configuration; and
a resonant circuit and a transformer connected between the input circuit and the output circuit.

14. The method of simulating a railway system of claim 9,
wherein in the process (a), executing a simulation program using the converter station model in software by the HILS device,
the converter station model uses a plurality of SRDAB converters connected in an ISOP configuration as a DC/DC converter, and
each of the of SRDAB converters includes:
an input circuit including a first switching element, a second switching element, a third switching element and a fourth switching element connected in series to each other along a half-bridge configuration, a first capacitor connected in parallel to the first switching element and the second switching element, and a second capacitor connected in parallel to the third switching element and the fourth switching element;
an output circuit including a first switching element, a second switching element, a third switching element and a fourth switching element connected to each other along a full-bridge configuration; and
a resonant circuit and a transformer connected between the input circuit and the output circuit.

15. The method of simulating a railway system of claim 13,
wherein in the process (a), connecting one side end of the transformer to a connection node for the first switching element and the second switching element,
connecting the other side end of the transformer to a connection node for the third switching element and the fourth switching element, and
connecting the resonant circuit between the connection node for the first switching element and the second switching element and the one side end of the transformer.

16. The method of simulating a railway system of claim 13,
wherein in the process (b),
performing a control method through the converter controller, which includes complementarily applying a first switching sequence to the first switching element and the second switching element and complementarily applying a second switching sequence to the third switching element and the fourth switching element, and
in the first switching sequence, a first pulse with a pulse width for a reference time T/2 and an amplitude of a first level, a second pulse with a pulse width for a time T/2−ΔT obtained by subtracting a predetermined period of time from the reference time and an amplitude of a second level, a third pulse with a pulse width for the reference time T/2 and an amplitude of the first level, and a fourth pulse with a pulse width for a time T/2+ΔT obtained by adding a predetermined period of time to the reference time and an amplitude of the second level are repeated periodically, and
in the second switching sequence, a first pulse with a pulse width for the reference time T/2 and an amplitude of the second level, a second pulse with a pulse width for the time T/2+ΔT obtained by adding a predetermined period of time to the reference time and an amplitude of the first level, a third pulse with a pulse width for the reference time T/2 and an amplitude of the second level, and a fourth pulse with a pulse width for the time T/2−ΔT obtained by subtracting a predetermined period of time from the reference time and an amplitude of the first level are repeated periodically, and
the first level is a high level, and the second level, which differs from the first level, is a low level.

17-30. (canceled)

31. The simulation system of a railway system of claim 6,
wherein the resonant circuit and the transformer are connected to each other between a connection node for the first switching element and the second switching element of the input circuit and a connection node for the third switching element and the fourth switching element of the input circuit,
the resonant circuit includes a capacitor and an inductor connected in series to each other,
one primary side end of the transformer is connected to the resonant circuit and the other primary side end is connected to the connection node for the third switching element and the fourth switching element of the input circuit, and
one secondary side end of the transformer is connected to a connection node for the first switching element and the second switching element of the output circuit and the other secondary side end is connected to a connection node for the third switching element and the fourth switching element of the output circuit.

32. The simulation system of a railway system of claim 6,
wherein the converter controller includes a control logic configured to complementarily apply a first switching sequence to the first switching element and the second switching element of the input circuit and complementarily apply a second switching sequence to the third switching element and the fourth switching element of the input circuit, and
in the first switching sequence, a first pulse with a pulse width for a reference time T/2 and an amplitude of a first level, a second pulse with a pulse width for a time T/2−ΔT obtained by subtracting a predetermined period of time from the reference time and an amplitude of a second level, a third pulse with a pulse width for the reference time T/2 and an amplitude of the first level, and a fourth pulse with a pulse width for a time T/2+ΔT obtained by adding a predetermined period of time to the reference time and an amplitude of the second level are repeated periodically, and
in the second switching sequence, a first pulse with a pulse width for the reference time T/2 and an amplitude of the second level, a second pulse with a pulse width for the time T/2+ΔT obtained by adding a predetermined period of time to the reference time and an amplitude of the first level, a third pulse with a pulse width for the reference time T/2 and an amplitude of the second level, and a fourth pulse with a pulse width for the time T/2−ΔT obtained by subtracting a predetermined period of time from the reference time and an amplitude of the first level are repeated periodically, and
the first level is a high level, and the second level, which differs from the first level, is a low level.

33. The method of simulating a railway system of claim 14,
wherein in the process (a), connecting one side end of the transformer to a connection node for the first switching element and the second switching element,
connecting the other side end of the transformer to a connection node for the third switching element and the fourth switching element, and
connecting the resonant circuit between the connection node for the first switching element and the second switching element and the one side end of the transformer.

34. The method of simulating a railway system of claim 14,
wherein in the process (b),
performing a control method through the converter controller, which includes complementarily applying a first switching sequence to the first switching element and the second switching element and complementarily applying a second switching sequence to the third switching element and the fourth switching element, and
in the first switching sequence, a first pulse with a pulse width for a reference time T/2 and an amplitude of a first level, a second pulse with a pulse width for a time T/2-AT obtained by subtracting a predetermined period of time from the reference time and an amplitude of a second level, a third pulse with a pulse width for the reference time T/2 and an amplitude of the first level, and a fourth pulse with a pulse width for a time T/2+ΔT obtained by adding a predetermined period of time to the reference time and an amplitude of the second level are repeated periodically, and
in the second switching sequence, a first pulse with a pulse width for the reference time T/2 and an amplitude of the second level, a second pulse with a pulse width for the time T/2+ΔT obtained by adding a predetermined period of time to the reference time and an amplitude of the first level, a third pulse with a pulse width for the reference time T/2 and an amplitude of the second level, and a fourth pulse with a pulse width for the time T/2−ΔT obtained by subtracting a predetermined period of time from the reference time and an amplitude of the first level are repeated periodically, and
the first level is a high level, and the second level, which differs from the first level, is a low level.
